(19) United States
(12) Patent Application Publication
(10) Pub. No.: US 2023/0143044 A1
(43) Pub. Date: May 11, 2023

(54) REMOTE EXECUTION OF A GAME PLAY PRODUCING OUTPUT

(71) Applicant: SG Gaming, Inc., Las Vegas, NV (US)

(72) Inventors: Sarath K. Sivadasan, Seattle, WA (US); Anand Singh, Las Vegas, NV (US)

(21) Appl. No.: 17/981,893

(22) Filed: Nov. 7, 2022

Related U.S. Application Data
(60) Provisional application No. 63/277,719, filed on Nov. 10, 2021.

(51) Int. Cl. G07F 17/32; G06F 7/58; H04L 9/00

(52) U.S. Cl. CPC G07F 17/3267; G07F 17/3244; G06F 7/588; H04L 9/50; H04L 2209/56

(57) ABSTRACT

A computer-implemented method can include: receiving a request from an entity to submit a wager corresponding to an electronic game to be executed on a remote electronic gaming device; inputting the wager into a queue corresponding to at least one of the remote electronic gaming device or the electronic game; receiving a game play outcome of a game play of the electronic game executed on the remote electronic gaming device; generating supplemental game play content associated with execution of at least one of the electronic game or the game play based at least in part on receipt of a second request from the entity; providing at least one of the supplemental game play content or the game play outcome to the entity; and recording on a blockchain, one or more events associated with the wager.

### PRIORITY CLAIM

The present application is based on and claims priority to U.S. Provisional Patent Application No. 63/277,719, having a filing date of Nov. 10, 2021, which is incorporated herein by reference in its entirety.

### FIELD

The present disclosure relates generally to integrated computer-implemented gaming systems having electronic gaming devices that execute electronic games.

### BACKGROUND

Computer-implemented gaming systems (hereinafter, “electronic gaming system(s)”) can have local and/or remote electronic gaming devices that respectively execute electronic games. Examples of such local and/or remote electronic gaming devices can include, for instance, electronic gaming machines (EGM), electronic table games (ETG), and/or another electronic gaming device.

### SUMMARY

Aspects and advantages of embodiments of the present disclosure will be set forth in part in the following description, or can be learned from the description, or can be learned through practice of the embodiments.

According to an example embodiment of the present disclosure, a computing system can include one or more processors. The computing system can further include one or more memory devices that can store instructions that, when executed by the one or more processors, can cause the computing system to perform operations. The operations can include receiving a request from an entity to submit a wager corresponding to an electronic game to be executed on a remote electronic gaming device. The operations can further include inputting the wager into a queue corresponding to at least one of the remote electronic gaming device or the electronic game. The operations can further include receiving a game play outcome of a game play of the electronic game executed on the remote electronic gaming device. The operations can further include prior to receiving or generating supplemental game play content associated with execution of at least one of the electronic game or the game play, providing the game play outcome to the entity.

According to another example embodiment of the present disclosure, a computer-implemented method can include receiving, by a computing system comprising one or more processors, a request from an entity to submit a wager corresponding to an electronic game to be executed on a remote electronic gaming device. The computer-implemented method can further include inputting, by the computing system, the wager into a queue corresponding to at least one of the remote electronic gaming device or the electronic game. The computer-implemented method can further include receiving, by the computing system, a game play outcome of a game play of the electronic game executed on the remote electronic gaming device. The computer-implemented method can further include generating, by the computing system, supplemental game play content associated with execution of at least one of the electronic game or the game play based at least in part on receipt of a second request from the entity. The computer-implemented method can further include providing, by the computing system, at least one of the supplemental game play content or the game play outcome to the entity. The computer-implemented method can further include recording, by the computing system, on a blockchain, one or more events associated with the wager.

According to another example embodiment of the present disclosure, an electronic gaming device can include one or more processors. The electronic gaming device can further include one or more memory devices that can store instructions that, when executed by the one or more processors, can cause the electronic gaming device to perform operations. The operations can include obtaining game play input data to be used to execute a game play of an electronic game associated with the electronic gaming device. The operations can further include executing the game play based at least in part on the game play input data. The operations can further include generating a game play outcome of the game play based at least in part on execution of the game play. The game play outcome lacking supplemental game play content associated with execution of at least one of the electronic game or the game play. The operations can further include providing the game play input data and the game play outcome lacking supplemental game play content to one or more remote computing devices to generate a recreation of the game play via the one or more remote computing devices based at least in part on the game play input data and the game play outcome lacking supplemental game play content. The recreation can include the supplemental game play content.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a block diagram of an example, non-limiting electronic gaming system that can facilitate remote execution of a game play according to example embodiments of the present disclosure.

FIG. 2 illustrates a block diagram of an example, non-limiting electronic gaming system that can facilitate remote execution of a game play according to example embodiments of the present disclosure.

FIGS. 3, 4, 9, and 10 each illustrate a flow diagram of an example, non-limiting computer-implemented method that can facilitate remote execution of a game play according to example embodiments of the present disclosure.

FIG. 5 is a perspective view of a gaming machine according to example embodiments of the present disclosure.

FIGS. 6A and 6B are block diagrams depicting the physical and logical components of the gaming machine of FIG. 5 according to example embodiments of the present disclosure.

FIG. 7 is a block diagram of the logical components of a gaming kernel according to example embodiments of the present disclosure.

FIGS. 8A and 8B are schematic block diagrams showing the hardware elements of a networked gaming system according to example embodiments of the present disclosure.

Reference numerals that are repeated across multiple figures are intended to identify the same features in various embodiments.

### DETAILED DESCRIPTION

Reference now will be made in detail to embodiments, one or more examples of which are illustrated in the figures. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that embodiments of the present disclosure cover such modifications and variations.

As referenced herein, the term “entity” refers to a human, a user, an end-user, a consumer, a computing device and/or program (e.g., a processor, computing hardware and/or software, an application, etc.), an agent, a machine learning (ML) and/or artificial intelligence (AI) algorithm, model, system, and/or application, and/or another type of entity that can implement one or more embodiments of the present disclosure as described herein, illustrated in the accompanying drawings, and/or included in the appended claims. As referenced herein, the terms “or” and “and/or” are generally intended to be inclusive, that is (i.e.), “A or B” or “A and/or B” are each intended to mean “A or B or both.” As referred to herein, the terms “first,” “second,” “third,” etc. can be used interchangeably to distinguish one component or entity from another and are not intended to signify location, functionality, or importance of the individual components or entities. As used herein, the terms “couple,” “couples,” “coupled,” and/or “coupling” refer to chemical coupling (e.g., chemical bonding), communicative coupling, electrical and/or electromagnetic coupling (e.g., capacitive coupling, inductive coupling, direct and/or connected coupling, etc.), mechanical coupling, operative coupling, optical coupling, and/or physical coupling.

As referenced herein, the term “remote electronic gaming device” refers to an electronic gaming device located at a geographical location that is different from the geographical location of an entity implementing one or more aspects of the present disclosure in accordance with one or more embodiments described herein. As referenced herein, the term “local electronic gaming device” refers to an electronic gaming device located at the same geographical location as an entity implementing one or more aspects of the present disclosure in accordance with one or more embodiments described herein.

Example aspects of the present disclosure are generally directed to an electronic gaming system having one or more local and/or remote electronic gaming devices (e.g., EGM, ETG, etc.) that can respectively execute one or more electronic games, where an entity (e.g., a player) can use a local electronic gaming device to participate (e.g., place wagers) in an electronic game that is executed on a remote electronic gaming device in accordance with at least one embodiment described herein. A problem with electronic gaming systems is that the output generated from execution of an electronic game and/or a game play of the electronic game can include content (e.g., graphics, video, audio, images, etc.) that can be computationally expensive and/or time consuming to generate, manage, and/or communicate. Therefore, the generation of such output can hinder the speed at which an electronic gaming device can execute a plurality of game plays corresponding to one or more electronic games. Additionally, the generation, management, and/or communication of such output can also hinder the efficiency, performance, and/or capacity of one or more computational components (e.g., hardware, software, etc.) of such an electronic gaming device. Moreover, the generation, management, and/or communication of such output can also hinder the efficiency, performance, and/or capacity of one or more computational and/or communication resources (e.g., computing device(s), network device(s), etc.) that are involved with the generation, management, and/or communication of such output.

Another problem with electronic gaming systems is that even if a local electronic gaming device and a remote electronic gaming device are each geographically located at a location where gambling is legal, it is difficult for an entity (e.g., a player) using the local electronic gaming device to participate (e.g., place wagers), in a trusted, timely, and/or secure manner, in an electronic game that is executed on the remote electronic gaming device.

According to example embodiments of the present disclosure, the electronic gaming system can facilitate generating a game play outcome of a game play of the electronic game executed on the remote electronic gaming device, where the game play outcome can lack supplemental game play content (e.g., graphics, video, audio, images, etc.) associated with the execution of the electronic game and/or the game play. In one or more embodiments, the electronic gaming system can facilitate providing the game play outcome to the entity via, for instance, the local electronic gaming device and/or one or more computing devices associated with the entity. In additional and/or alternative embodiments of the present disclosure, the electronic gaming system can facilitate providing a recreation of the game play to the entity via, for instance, the local electronic gaming device and/or one or more computing devices associated with the entity, where the recreation can include the supplemental game play content (e.g., graphics, video, audio, images, etc.) associated with the execution of the electronic game and/or the game play. Further, the electronic gaming system according to at least one embodiment of the present disclosure can use blockchain and/or smart contract technology to ensure that such participation by the entity in the electronic game executed on the remote electronic gaming device is conducted in a trusted, timely, and/or secure manner.

To facilitate such electronic game participation by the entity across one or more local and/or remote electronic gaming devices of the electronic gaming system in accordance with one or more embodiments of the present disclosure, the electronic gaming system can include a computing system that can receive a request from the entity to submit a wager corresponding to an electronic game to be executed on a remote electronic gaming device of the electronic gaming system. For example, in one or more embodiments, the computing system can receive such a request from the entity via a network and/or one or more computing devices that can be employed by the entity such as, for instance, a local electronic gaming device, a client computing device associated with the entity (e.g., a laptop, a smart phone, a tablet, etc.), and/or another computing device.

In at least one embodiment, the network can include and/or constitute a communication network such as, for instance, a wide area network (WAN), a local area network (LAN), the Internet, and/or another network. In an example embodiment, the computing system can include, be coupled to, and/or otherwise be associated with a computing device such as, for instance, a computer, a host computing device, a server computing device, and/or another computing device. In this example embodiment, the computing device can include and/or otherwise be coupled to one or more interface and/or communication components that can facilitate receipt of such a request from the entity over the network (e.g., WAN, LAN, the Internet, etc.). In some embodiments described herein, the interface component(s) can include and/or constitute, for instance, a graphical user interface (GUI), an application programming interface (API), a representational state transfer API (REST API), and/or another interface component. In at least one embodiment, the communication component(s) can include and/or constitute, for instance, one or more communication interface components, transceivers, receivers, ports, controllers, antennas, and/or other communication components.

In one or more embodiments of the present disclosure, based at least in part on receipt of such a request from the entity, the computing system can associate the entity, the wager, the electronic game, the remote electronic gaming device, and/or the electronic gaming system with a smart contract that can perform at least one of execution, control, or documentation of one or more events associated with the wager. In these one or more embodiments, the smart contract can execute, control, and/or document the one or more events associated with the wager based at least in part on one or more predefined rules that can be defined by, for instance, the entity.

In at least one embodiment described herein, the computing system can input the wager into a queue that can correspond to the electronic game and/or the remote electronic gaming device. In one or more embodiments, the computing system can employ the smart contract to input the wager and/or data indicative of the wager into the queue. For example, in at least one embodiment, the smart contract can input the wager and/or the data indicative of the wager into the queue based at least in part on one or more predefined rules. In some embodiments, such one or more predefined rules can be defined by, for example, the entity and/or another entity. For instance, in one example embodiment, the wager can include and/or constitute a plurality of sub-wagers and/or the one or more predefined rules can define details and/or terms (e.g., conditional terms, if-then statements, etc.) that can specify how the entity wants to submit one or more of such sub-wagers to the electronic game. In this example embodiment, the smart contract can facilitate inputting the sub-wager(s) and/or data indicative of the sub-wager(s) into the queue according to such details and/or terms that can specify how the entity wants to submit the sub-wager(s) to the electronic game.

In accordance with at least one embodiment of the present disclosure, based at least in part on inputting the above-described wager, sub-wager(s), and/or data that can be indicative of the wager and/or sub-wager(s) into such a queue, the computing system can provide the entity access to view one or more queue entities in the queue. In some embodiments, such one or more queue entities can include and/or constitute, for instance, data indicative of the wager and/or sub-wager(s) and/or data indicative of one or more second wagers that can also correspond to the electronic game and/or the remote electronic gaming device. In these embodiments, such one or more second wagers can be associated with the entity and/or one or more second entities (e.g., a 3^{rd} party entity, another player, etc.). In an example embodiment, the computing system can provide the entity access to view such one or more queue entities on a display (e.g., monitor, screen, etc.) of one or more computing devices that can include, but are not limited to, for instance, a local electronic gaming device, a client computing device (e.g., a laptop or smart phone associated with the entity, etc.), a second remote electronic gaming device, a remote computing device (e.g., a laptop or smart phone associated with another entity, etc.), and/or another computing device.

In one or more embodiments described herein, the computing system can receive a game play outcome of a game play of the electronic game executed on the remote electronic gaming device. In some embodiments, such a game play outcome can include and/or constitute game play outcome data that can result from the execution of the electronic game and/or the game play by the remote electronic gaming device. For example, in at least one embodiment, the game play outcome can include and/or constitute: data that can be indicative of the game play outcome (e.g., digital data, analog data, binary data, etc.); data that can be indicative of a game play result (e.g., win, loss, tie, etc.); and/or other data (e.g., metadata, embedded data, scripts, code, etc.) that can be associated with the game play outcome.

In one or more embodiments, the game play outcome of the game play can lack supplemental game play content that can be associated with the execution (e.g., by the remote electronic gaming device) of the electronic game and/or the game play. In these one or more embodiments, the supplemental game play content that can be lacking from the game play outcome can include, but is not limited to: visual content (e.g., graphical content, graphics, video, images, media content, etc.); audio content (e.g., music, game play instructions, notifications, alarms, etc.); textual content (e.g., textual data, numerical data, alphanumerical data, etc.); and/or other data (e.g., metadata, embedded data, scripts, code, etc.) that can be associated with the execution of the electronic game and/or the game play by the remote electronic gaming device. In this way, the computing system can provide the game play outcome to the entity prior to receiving or generating supplemental game play content associated with execution of at least one of the electronic game or game play.

According to one or more embodiments of the present disclosure, the computing system can receive the game play outcome via the above-described network (e.g., WAN, LAN, the Internet, etc.) and the computing device that can be included in, coupled to, and/or otherwise associated with the computing system (e.g., a computer, a host computing device, a server computing device, etc.). In these one or more embodiments, the computing system can receive the game play outcome from, for instance, the remote electronic gaming device based at least in part on (e.g., in response to) execution of the electronic game and/or the game play on and/or by the remote electronic gaming device.

In at least one embodiment of the present disclosure, the computing system can provide the game play outcome to the entity. For example, in at least one embodiment, the game play outcome can include and/or constitute data that can be indicative of a game play result such as, for instance, data that can be indicative of a win, a loss, a tie, and/or another outcome that can result from execution of the game play. In one or more embodiments, the computing system can provide the game play outcome and/or data that can be indicative of the game play outcome to the entity via, for instance: the above-described network (e.g., WAN, LAN, the Internet, etc.); the above-described computing device that can be included in, coupled to, and/or otherwise associated with the computing system (e.g., a computer, a host computing device, a server computing device, etc.); and/or the above-described computing device(s) that can be employed by the entity (e.g., a local electronic gaming device, a client computing device associated with the entity (e.g., a laptop, a smart phone, a tablet, etc.), and/or another computing device).

According to one or more embodiments described herein, the computing system can receive game play input data that can used by the remote electronic gaming device and/or the electronic game to execute the game play. For instance, in an example embodiment, the computing system can receive game play input data that can used by the remote electronic gaming device and/or the electronic game to execute the game play, where the execution of the game play using the game play input data can provide the above-described game play outcome of the game play. In one or more embodiments, the computing system can receive the game play input data before, during, and/or after execution of the game play by the remote electronic gaming device and/or the electronic game. For instance, in these one or more embodiments, the computing system can receive the game play input data before runtime, at runtime, during runtime, and/or after runtime of the game play. In one embodiment, the computing system can receive the game play input data from the remote electronic gaming device via, for instance: the above-described network (e.g., WAN, LAN, the Internet, etc.); and/or the above-described computing device that can be included in, coupled to, and/or otherwise associated with the computing system (e.g., a computer, a host computing device, a server computing device, etc.). In another embodiment, the computing system can store the game play input data locally (e.g., on a memory device of the computing system) and/or remotely (e.g., on a client memory device, a memory device of an electronic gaming device, etc.).

In at least one embodiment, the above-described game play input data can include and/or constitute, for instance, a random number that can be generated by a random number generator. For example, in this embodiment, the random number can include and/or constitute a single random number, a sequence of random numbers, a set of random numbers, and/or another random number that can be generated by, for instance, a random number generator. In some embodiments, the random number generator can be included in, coupled to, and/or otherwise associated with the remote electronic gaming device. In these embodiments, the remote electronic gaming device and/or the electronic game can obtain a random number from the random number generator and can further execute the game play using such a random number to produce the above-described game play outcome of the game play (e.g., the game play outcome lacking supplemental game play content associated with execution of the electronic game and/or the game play).

In one or more embodiments of the present disclosure, the remote electronic gaming device can provide the entity and/or another entity (e.g., a 3^{rd} party entity, another player, a regulator entity, etc.) with the random number used to execute the game play and/or generate the corresponding game play outcome produced therefrom, where the game play outcome can lack the above-described supplemental game play content. For example, in one embodiment, based at least in part on receipt of a request from the entity and/or another entity, the remote electronic gaming device can provide the random number and/or the corresponding game play outcome. In an example embodiment, the remote electronic gaming device can receive such a request and/or provide the random number and/or the game play outcome to the entity and/or another entity via, for instance: the above-described network (e.g., WAN, LAN, the Internet, etc.); the above-described computing device that can be included in, coupled to, and/or otherwise associated with the computing system (e.g., a computer, a host computing device, a server computing device, etc.); and/or one or more computing devices that can be employed by the entity and/or another entity (e.g., a local electronic gaming device, a client computing device associated with the one or more entities (e.g., a laptop, a smart phone, a tablet, etc.), and/or another computing device). In another embodiment, the remote electronic gaming device can store the random number and/or the game play outcome locally (e.g., on a memory device of the remote electronic gaming device) and/or remotely (e.g., on a client memory device, a memory device of the computing system, etc.).

In accordance with one or more embodiments described herein, the computing system can receive a request from the entity and/or another entity (e.g., a 3^{rd} party entity, another player, a regulator entity, etc.) to view a recreation of the game play, where the recreation can include and/or constitute some or all the above-described supplemental game play content. In these one or more embodiments, the computing system can receive such a request from the entity and/or another entity via, for instance: the above-described network (e.g., WAN, LAN, the Internet, etc.); the above-described computing device that can be included in, coupled to, and/or otherwise associated with the computing system (e.g., a computer, a host computing device, a server computing device, etc.); and/or one or more computing devices that can be employed by the entity and/or another entity (e.g., a local electronic gaming device, a client computing device associated with the one or more entities (e.g., a laptop, a smart phone, a tablet, etc.), and/or another computing device).

In one or more embodiments of the present disclosure, based at least in part on (e.g., in response to) receipt of such a request from the entity and/or another entity to view a recreation of the game play, the computing system can generate the recreation of the game play based at least in part on (e.g., using) the above-described game play input data. In these one or more embodiments, such a recreation that can be generated by the computing system can include and/or constitute some or all of the supplemental game play content described above. In one embodiment, to facilitate generation of such a recreation by the computing system, the computing system can generate some or all of the supplemental game play content described above (e.g., using the above-described game play input data).

In one or more embodiments, based at least in part on (e.g., in response to) receipt of such a request to view a recreation of the game play, the computing system can generate the recreation of the game play using, for instance, a random number that was previously used by the remote electronic gaming device and/or the electronic game to execute the game play. In these one or more embodiments, the recreation of the game play can include and/or constitute some or all of the above-described supplemental game play content that can be associated with the execution of the electronic game and/or the game play by, for instance, the remote electronic gaming device. For example, in one or more embodiments, the supplemental game play content can include and/or constitute at least one of graphical content, video content, media content, image content, audio content, or textual content. In at least one example embodiment, such supplemental game play content can include and/or constitute, for instance: visual content (e.g., graphical content, graphics, video, images, media content, etc.); audio content (e.g., music, game play instructions, notifications, alarms, etc.); textual content (e.g., textual data, numerical data, alphanumerical data, etc.); and/or other data (e.g., metadata, embedded data, scripts, code, etc.) that can be associated with the execution (e.g., by the remote electronic gaming device) of the electronic game and/or the game play.

According to one or more embodiments described herein, the computing system can provide such a recreation of the game play to the entity and/or another entity, where the recreation can include and/or constitute some or all of the above-described supplemental game play content that can be associated with the execution of the electronic game and/or the game play. For example, in one or more embodiments of the present disclosure, the computing system can provide data that can be associated with and/or indicative of the recreation of the game play to one or more computing devices that can be associated with the entity and/or another entity. In these one or more embodiments, such data that can be associated with and/or indicative of the recreation can include and/or constitute some or all of the above-described supplemental game play content.

In at least one example embodiment, the computing system can provide the recreation of the game play, and/or the data that can be associated therewith and/or indicative thereof, to one or more computing devices that can be associated with the entity and/or another entity, where such computing device(s) can include and/or constitute, for instance: a local electronic gaming device; a client computing device (e.g., a laptop, a smart phone, etc.); a second remote electronic gaming device (e.g., another remote electronic gaming device located at a different geographical location from the remote electronic gaming device, the entity, and/or another entity); a remote computing device (e.g., a laptop, smart phone, etc.); and/or another computing device. In this example embodiment, the computing system can provide such a recreation of the game play, and/or the data that can be associated therewith and/or indicative thereof, to such computing device(s) that can be associated with the entity and/or another entity via, for instance: the above-described network (e.g., WAN, LAN, the Internet, etc.); and/or the above-described computing device that can be included in, coupled to, and/or otherwise associated with the computing system (e.g., a computer, a host computing device, a server computing device, etc.).

In one or more embodiments described herein, the computing system can record one or more events associated with the wager on a blockchain. In at least one embodiment described herein, the computing system can use the above-described smart contract that can be associated with at least the wager and/or the entity to record on a blockchain such one or more events based at least in part on (e.g., according to) one or more predefined rules. In at least one embodiment, the one or more predefined rules can be defined by, for instance, the entity and/or another entity. In some embodiments, the one or more predefined rules can define details and/or terms (e.g., conditional terms, if-then statements, etc.) that can specify, for instance: the one or more events associated with the wager that the entity wants to record on a blockchain; the blockchain(s) on which the entity wants to record the one or more events associated with the wager; and/or another detail and/or term. In these embodiments, the smart contract can facilitate recording on a blockchain(s) the one or more events associated with the wager according to such details and/or terms that can specify the criteria for recording such one or more events on the blockchain(s).

According to at least one embodiment of the present disclosure, the one or more events that can be recorded on a blockchain by the computing system can include, but are not limited to, for instance: one or more life cycle events associated with the wager (e.g., creation, termination, etc.); one or more transactions associated with the wager (e.g., submittal of the wager to an electronic gaming device and/or electronic game, transfer of ownership of the wager, return of wager resulting from a game play win associated with the wager, loss of the wager resulting from a game play loss associated with the wager, etc.); one or more monetary transactions associated with application of the wager (e.g., transfer of currency associated with submittal of the wager to an electronic gaming device and/or electronic game, transfer of currency won resulting from a game play win associated with the wager, transfer of currency lost resulting from a game play loss associated with the wager, etc.); and/or another event associated with the wager.

Aspects of the present disclosure provide numerous technical effects and benefits. For example, in multiple embodiments of the present disclosure, the above-described remote electronic gaming device can include and/or constitute an electronic gaming machine (EGM), an electronic table game (ETG), a server device, and/or another electronic gaming device that can include and/or otherwise be associated with (e.g., coupled to): one or more processors; one or more memory devices; one or more networks (e.g., communication network, the Internet, etc.); and/or one or more other computing devices and/or computing components. In these example embodiments, by generating a recreation of a game play of an electronic game that was previously executed by such a remote electronic gaming device, the computing system according to one or more embodiments described herein can allow for the remote electronic gaming device to eliminate operations associated with generating, storing, rendering, and/or communicating the above-described supplemental game play content (e.g., visual, audio, textual, etc.) associated with execution of the electronic game, execution of the game play, and/or output of the game play outcome. In these example embodiments, by allowing for the remote electronic gaming device to eliminate such operations, the computing system can further allow for the remote electronic gaming device to execute a greater number of game play executions and/or a greater number of corresponding game play outcomes than it otherwise could within a given duration of time.

In additional and/or alternative embodiments, the computing system according to at least one embodiment described herein can generate a recreation of a game play using game play input data that was previously used by a remote electronic gaming device and/or an electronic game thereof to execute the game play, where such a recreation of the game play can include and/or constitute some or all of the above-described supplemental game play content. For instance, in these embodiments, the remote electronic gaming device and/or the electronic game can use a random number generated by a random number generator to execute the game play and/or produce a corresponding game play outcome, where such a random number generator can be included with, coupled to, and/or otherwise associated with the remote electronic gaming device and/or the electronic game. In these embodiments, the computing system can use such a random number to generate a recreation of the game play that can include and/or constitute some or all of the above-described supplemental game play content. Consequently, in these embodiments, the computing system described in at least one embodiment herein can allow for the remote electronic gaming device to perform operations associated with generating, obtaining, storing, rendering, and/or communicating the random number, rather than the above-described supplemental game play content (e.g., visual, audio, textual, etc.) associated with execution of the electronic game and/or the game play.

In the above embodiments, by using the above-described game play input data such as, for instance, a random number to generate a recreation of a game play that was executed by a remote electronic gaming device and/or an electronic game thereof, the computing system according to at least one embodiment described herein can reduce the computational workload (e.g., processing), data storage workload, and/or data communication workload of the remote electronic gaming device. Accordingly, in these example embodiments, the computing system can thereby: increase processing capacity of at least one processor associated with the remote electronic gaming device; increase memory capacity of at least one memory device associated with the remote electronic gaming device; increase communication bandwidth capacity of at least one communication component associated with the remote electronic gaming device; and/or reduce computational costs associated with the remote electronic gaming device.

In another example embodiment, by using the above-described game play data such as, for instance, a random number to generate a recreation of a game play that was executed by a remote electronic gaming device and/or an electronic game thereof, the computing system according to at least one embodiment described herein can reduce the computational workload (e.g., processing), data storage workload, and/or data communication workload of one or more computing and/or communication resources of an electronic gaming system that includes and/or is otherwise associated with the computing system and/or the remote electronic gaming device described herein. Therefore, in this example embodiment, the computing system can thereby facilitate: increased processing capacity of at least one processor of the electronic gaming system; increased memory capacity of at least one memory device of the electronic gaming system; increased bandwidth capacity of a network associated with the electronic gaming system; and/or reduced computational costs associated with at least one of the electronic gaming system, one or more computing and/or communication resources thereof, and/or the computing system.

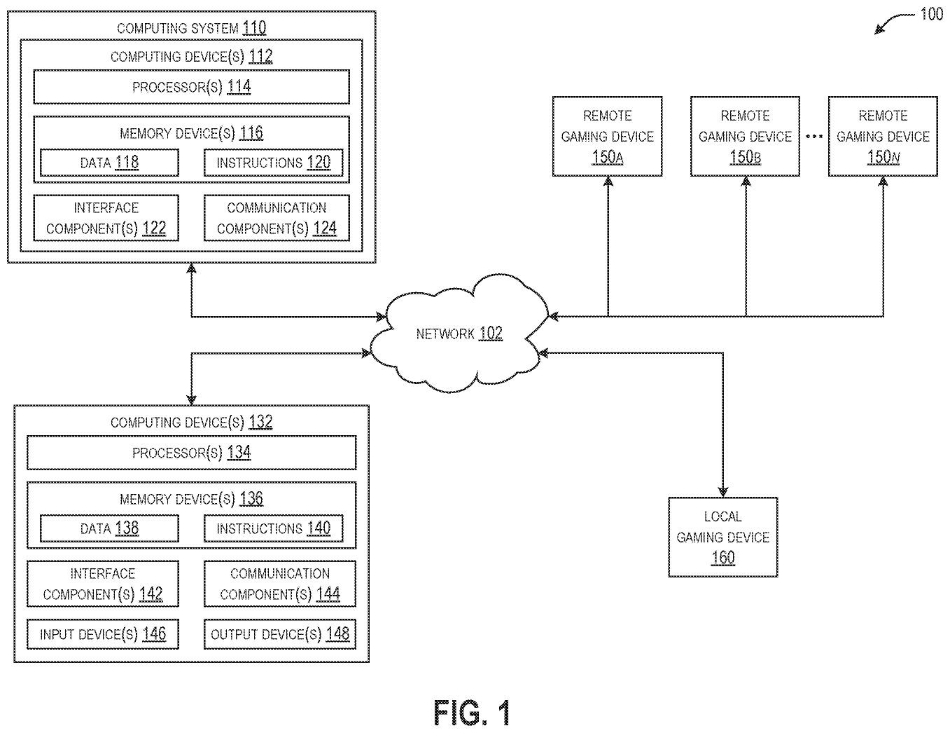

FIG. 1 illustrates a block diagram of an example, non-limiting electronic gaming system 100 that can facilitate remote execution of a game play according to example embodiments of the present disclosure. Electronic gaming system 100 according to at least one embodiment of the present disclosure can include and/or constitute an integrated computer-implemented gaming system.

In one or more embodiments described herein, electronic gaming system 100 can include one or more local and/or remote electronic gaming devices that can respectively execute one or more electronic games and/or one or more game plays corresponding to such one or more electronic games. In these one or more embodiments, an entity (e.g., a player) can use a local electronic gaming device and/or a computing device of electronic gaming system 100 to participate (e.g., place wagers) in an electronic game that can be executed on a remote electronic gaming device in accordance with at least one embodiment described herein. As illustrated in the example embodiment depicted in FIG. 1, electronic gaming system 100 can include a network 102, a computing system 110, one or more computing devices 132, one or more remote gaming devices 150A, 150B, 150N (where “N” represents a total quantity of remote gaming devices), and/or a local gaming device 160.

According to one or more embodiments of the present disclosure, network 102 can include and/or constitute a communications network. For example, in some embodiments, network 102 can include and/or constitute a wide area network (WAN), a local area network (LAN), an intranet, an extranet, the Internet, and/or another communications network. In at least one embodiment, network 102 can include one or more wired and/or wireless connections and/or links that can facilitate communication between one or more components of electronic gaming system 100 such as, for instance, communication between computing system 110, one or more computing devices 112, one or more computing devices 132, remote gaming devices 150A, 150B, 150N, and/or local gaming device 160. In one or more embodiments, communication over network 102 can be performed via such one or more wired and/or wireless connections and/or links using, for instance: one or more communication protocols (e.g., transmission control protocol/internet protocol (TCP/IP), hypertext transfer protocol (HTTP), simple mail transfer protocol (SMTP), file transfer protocol (FTP), etc.); one or more encodings and/or formats (e.g., hypertext markup language (HTML), extensible markup language (XML), etc.); and/or one or more protection and/or encryption schemes (e.g., virtual private network (VPN), secure hypertext transfer protocol (S-HTTP), secure sockets layer (SSL), etc.).

In the example embodiment illustrated in FIG. 1, computing system 110 can include and/or constitute any combination of systems and/or devices including one or more computing systems and/or one or more computing devices. In some embodiments, computing system 110 can be coupled (e.g., networked) to one or more computing systems and/or one or more computing devices via, for instance, network 102. In these embodiments, computing system 110 can operate in different configurations including, for instance, as a server (e.g., a server computing device), a host computing device, a client machine (e.g., in a client-server network environment), as a peer machine (e.g., in a peer-to-peer or distributed network environment), and/or another configuration. Although computing system 110 is depicted in the example embodiment illustrated in FIG. 1 as a single device, computing system 110 according to one or more embodiments of the present disclosure can include a collection and/or combination of devices that can, individually and/or in combination with one or more other devices, execute a set of one or more instructions to perform one or more of the operations discussed herein.

As illustrated in the example embodiment depicted in FIG. 1, computing system 110 can include one or more computing devices 112. In at least one embodiment described herein, one or more computing devices 112 can include one or more processors 114, one or more memory devices 116, one or more interface components 122, and/or one or more communication components 124. In this embodiment, one or more memory devices 116 can include data 118 and/or instructions 120.

According to at least one embodiment of the present disclosure, one or more computing devices 112 can include and/or constitute any type of computing device such as, for example: a personal computing device (e.g., a desktop computing device), a mobile computing device (e.g., a smartphone or tablet), a wearable computing device (e.g., a smartwatch), an embedded computing device, a web appliance, a server, a network router, a switch, a bridge, or any device capable of executing a set of instructions (e.g., any combination of instructions which can include sequential instructions and/or parallel instructions) associated with one or more operations and/or one or more actions to be performed by computing system 110 and/or any of the constituent components and/or devices of computing system 110.

In at least one embodiment described herein, one or more processors 114 can include and/or constitute any processing device including, but not limited to, for instance: a processor core, a microprocessor, an application-specific integrated circuit (ASIC), a field-programmable gate array (FPGA), a controller, a microcontroller, and/or another processor. In one or more embodiments, one or more processors 114 can include and/or constitute one processor or a plurality of processors that can be coupled to one another (e.g., operatively connected). In some embodiments, one or more processors 114 can include and/or constitute one or more complex instruction set computing (CISC) microprocessors, one or more reduced instruction set computing (RISC) microprocessors, one or more very long instruction word (VLIW) microprocessors, and/or one or more processors that are configured to implement other instruction sets and/or any of the operations described herein with respect to computing system 110 and/or one or more computing devices 112.

In at least one embodiment of the present disclosure, one or more memory devices 116 can be used to store data and/or information. In one or more embodiments, one or more memory devices 116 can include and/or constitute one or more computer-readable storage media, one or more non-transitory computer-readable storage media, and/or one or more machine-readable storage media. Although one or more memory devices 116 are depicted in FIG. 1 as a single unit (e.g., a single medium), such computer-readable and/or machine-readable storage media according to one or more embodiments of the present disclosure can include and/or constitute a single medium or multiple media (e.g., a centralized or distributed database, and/or associated caches and servers) that can store one or more sets of instructions. Further, in these one or more embodiments, such computer-readable and/or machine-readable storage media can include and/or constitute any medium that can: store, encode, and/or carry a set of instructions to be executed by a computing device; and/or cause the computing device to perform any of the one or more operations described herein. In some embodiments, such computer-readable and/or machine-readable storage media can include and/or constitute one or more solid-state memories, one or more optical media, and/or one or more magnetic media. In at least one embodiment described herein, one or more memory devices 116 can include and/or constitute, for instance, random access memory (RAM), read only memory (ROM), erasable programmable read only memory (EPROM), electrically erasable programmable read only memory (EEPROM), one or more flash memory devices, one or more magnetic storage devices (e.g., one or more hard disk drives), and/or another type of memory device.

In accordance with at least one embodiment described herein, one or more processors 114 can be configured to execute one or more instructions to perform the operations described herein including, for example, one or more operations associated with remote execution of a game play producing a game play outcome lacking supplemental game play content. Further, in one or more embodiments, one or more memory devices 116 can store data 118 and/or instructions 120, which can be executed by one or more processors 114 to cause one or more computing devices 112 to perform one or more operations.

Data 118 according to one or more embodiments of the present disclosure can include, for instance, the above-described game play input data that can be used by a remote electronic gaming device and/or an electronic game to execute a game play. For example, in at least one embodiment, data 118 can include one or more random numbers that can be generated by a random number generator. Further, in one or more embodiments, instructions 120 can include one or more instructions to use data including, for instance, data 118 to perform the one or more operations described herein. In some embodiments, one or more memory devices 116 can be used to store one or more applications (e.g., software applications) that can be operated by one or more processors 114 to perform one or more operations in accordance with one or more embodiments of the present disclosure. In at least one embodiment described herein, data 118, instructions 120, and/or such one or more applications can be associated with electronic gaming system 100 and/or one or more components thereof (e.g., computing system 110, one or more computing devices 112, one or more computing devices 132, one or more remote gaming devices 150A, 150B, 150N, local gaming device 160, etc.).

In one or more embodiments, one or more interface components 122 can include and/or constitute one or more interface components that can facilitate input of data into and/or output of data from computing system 110 and/or one or more computing devices 112 in accordance with one or more embodiments described herein. For example, in at least one embodiment, one or more interface components 122 can include and/or constitute, for instance, a graphical user interface (GUI), an application programming interface (API), a representational state transfer API (REST API), and/or another interface component.

In one or more embodiments, one or more communication components 124 can include and/or constitute one or more network interface components that can support network communications between systems and/or devices of the present disclosure in accordance with one or more embodiments described herein. For example, in at least one embodiment, one or more communication components 124 can allow computing system 110 and/or one or more computing devices 112 to communicate with one or more computing devices 132, one or more remote gaming devices 150A, 150B, 150N, and/or local gaming device 160 via network 102. In some embodiments, one or more communication components 124 can support communication via networks that can include, for instance, a wide area network (WAN), a local area network (LAN), an intranet, an extranet, the Internet, and/or another communications network. In at least one embodiment described herein, one or more communication components 124 can include and/or constitute one or more network interface components such as, but not limited to, one or more transmitters, receivers, ports, controllers, antennas, and/or another network interface component.

As illustrated in the example embodiment depicted in FIG. 1, one or more computing devices 132 can include one or more processors 134, one or more memory devices 136, one or more interface components 142, one or more communication components 144, one or more input devices 146, and/or one or more output devices 148. In this example embodiment, one or more memory devices 136 can include data 138 and/or instructions 140.

In at least one embodiment of the present disclosure, one or more processors 134, one or more memory devices 136, data 138, instructions 140, one or more interface components 142, and/or one or more communication components 144 can respectively include any of the attributes and/or capabilities of one or more processors 114, one or more memory devices 116, data 118, instructions 120, one or more interface components 122, and/or one or more communication components 124. Further, in one or more embodiments, one or more processors 134 and/or one or more memory devices 136 can each be configured to respectively perform any of the operations described herein with respect to one or more computing devices 132 and/or any of the operations performed by one or more processors 114 and/or one or more memory devices 116.

In the example embodiment depicted in FIG. 1, one or more input devices 146 can be operable and/or used to receive input (e.g., entity input). In at least one embodiment, one or more input devices 146 can include, for instance, one or more touch sensitive devices (e.g., a touch screen display), one or more keyboards, one or more pointing devices, (e.g., mouse device, a stylus device), one or more buttons (e.g., ON/OFF buttons and/or YES/NO buttons), one or more microphones, one or more cameras (e.g., cameras that can be used to detect gestures that can trigger one or more operations by one or more computing devices 132), and/or another input device.

In at least one embodiment described herein, one or more output devices 146 can include, for instance: one or more display devices (e.g., liquid-crystal display (LCD), organic light emitting diodes (OLED) display, mini-LED display, micro-LED display, plasma display, cathode-ray tube (CRT) display, etc.); one or more light sources (e.g., LEDs); one or more loudspeaker devices; one or more haptic output devices (e.g., one or more devices that are configured to generate vibratory output); and/or another output device. By way of example, in some embodiments, one or more output devices 146 can be operable and/or used to display a graphical user interface (GUI) via a display device (e.g., a monitor, screen, etc.) that can include, for instance, a touch screen layer that can be configured to detect one or more entity inputs. In one or more example embodiments, one or more output devices 146 can be operable and/or used to render and/or output content that can include, but is not limited to, for instance: visual content (e.g., graphical content, graphics, video, images, media content, etc.); audio content (e.g., music, game play instructions, notifications, alarms, etc.); textual content (e.g., textual data, numerical data, alphanumerical data, etc.); and/or other data (e.g., metadata, embedded data, scripts, code, etc.) that can be associated with the execution of an electronic game and/or a game play.

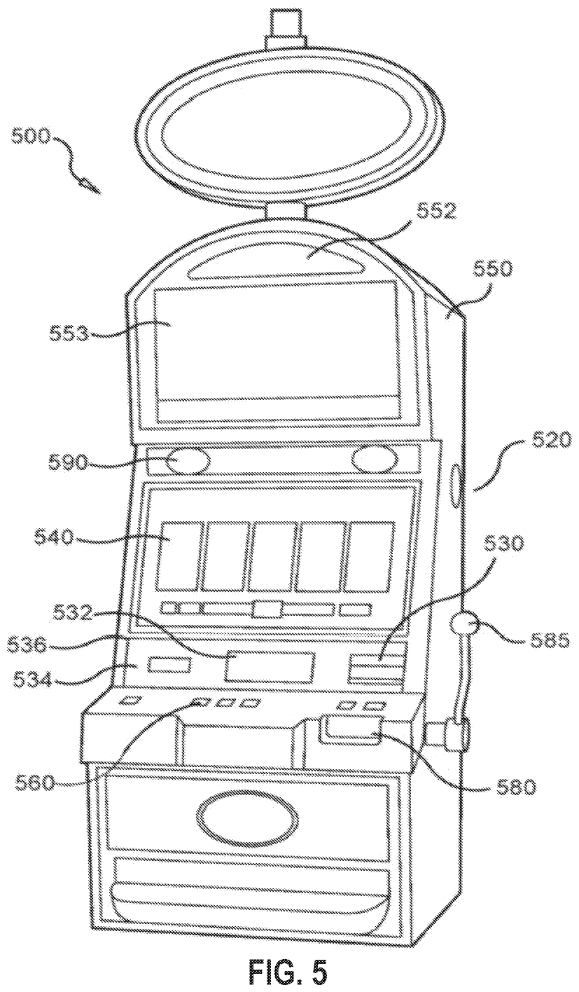

In the example embodiment depicted in FIG. 1, one or more remote gaming devices 150A, 150B, 150N can include and/or constitute one or more remote electronic gaming devices and/or machines. For example, in at least one embodiment, one or more remote gaming devices 150A, 150B, 150N can respectively include and/or constitute an electronic gaming device and/or machine that can: execute one or more electronic games and/or one or more game plays thereof; and/or be located at a geographical location that is different from another geographical location where an entity (e.g., a player, a regulator entity, etc.) participating in and/or requesting data associated with such electronic game(s) and/or game play(s) is located. In one example embodiment, one or more remote gaming devices 150A, 150B, 150N can respectively include and/or constitute an electronic gaming device such as, but not limited to, an electronic gaming machine (EGM), an electronic table game (ETG), and/or another electronic gaming device and/or machine. In another example embodiment, one or more remote gaming devices 150A, 150B, 150N can respectively include and/or constitute gaming machine 500, electronic gaming machine 601, and/or one of gaming machines 803 described below and/or illustrated in the example embodiments depicted in FIGS. 5, 6A, 6B, 7, 8A, and 8B.

In the example embodiment depicted in FIG. 1, local gaming device 160 can include and/or constitute a local electronic gaming device and/or machine. For example, in at least one embodiment, local gaming device 160 can include and/or constitute an electronic gaming device and/or machine that can: execute one or more electronic games and/or one or more game plays thereof; and/or be located at the same geographical location as an entity (e.g., a player, a regulator entity, etc.) participating in and/or requesting data associated with such electronic game(s) and/or game play(s) is located. In one example embodiment, local gaming device 160 can include and/or constitute an electronic gaming device such as, but not limited to, an electronic gaming machine (EGM), an electronic table game (ETG), and/or another electronic gaming device and/or machine. In another example embodiment, local gaming device 160 can include and/or constitute gaming machine 500, electronic gaming machine 601, and/or one of gaming machines 803 described below and/or illustrated in the example embodiments depicted in FIGS. 5, 6A, 6B, 7, 8A, and 8B.

In accordance with at least one embodiment of the present disclosure, an entity (e.g., a player) can use one or more computing devices 132 and/or local gaming device 160 to participate (e.g., place wagers) in an electronic game that is executed on one or more remote gaming devices 150A, 150B, 150N. In one or more embodiments described herein, computing system 110 and/or one or more computing devices 112 can facilitate receiving a game play outcome of a game play of the electronic game that can be executed on one or more remote gaming devices 150A, 150B, 150N, where the game play outcome can lack supplemental game play content (e.g., graphics, video, audio, images, etc.) associated with the execution of the electronic game and/or the game play. In these one or more embodiments, computing system 110 and/or one or more computing devices 112 can facilitate providing the game play outcome to the entity via, for instance, one or more computing devices 132 and/or local gaming device 160. In additional and/or alternative embodiments of the present disclosure, computing system 110 and/or one or more computing devices 112 can facilitate providing a recreation of the game play to the entity via, for instance, one or more computing devices 132 and/or local gaming device 160, where the recreation can include the supplemental game play content (e.g., graphics, video, audio, images, etc.) associated with the execution of the electronic game and/or the game play. Further, according to at least one embodiment of the present disclosure, computing system 110 and/or one or more computing devices 112 can use blockchain and/or smart contract technology to ensure that such participation by the entity in the electronic game executed on one or more remote gaming devices 150A, 150B, 150N is conducted in a trusted, timely, and/or secure manner.

To facilitate such electronic game participation by the entity across one or more local and/or remote electronic gaming devices of electronic gaming system 100 in accordance with one or more embodiments of the present disclosure, computing system 110 and/or one or more computing devices 112 can receive a request from the entity to submit a wager corresponding to an electronic game to be executed on one or more remote gaming devices 150A, 150B, 150N. For example, in one or more embodiments, computing system 110 and/or one or more computing devices 112 can receive such a request from the entity via network 102, one or more computing devices 132, and/or local gaming device 160.

In one or more embodiments of the present disclosure, based at least in part on receipt of such a request from the entity, computing system 110 and/or one or more computing devices 112 can associate the entity, the wager, the electronic game, one or more computing devices 132, one or more remote gaming devices 150A, 150B, 150N, local gaming device 160, and/or electronic gaming system 100 with a smart contract that can perform at least one of execution, control, or documentation of one or more events associated with the wager. In these one or more embodiments, the smart contract can execute, control, and/or document the one or more events associated with the wager based at least in part on one or more predefined rules that can be defined by, for instance, the entity.

In at least one embodiment described herein, computing system 110 and/or one or more computing devices 112 can input the wager into a queue that can correspond to the electronic game and/or one or more remote gaming devices 150A, 150B, 150N. In one or more embodiments, computing system 110 and/or one or more computing devices 112 can employ the smart contract to input the wager and/or data indicative of the wager into the queue. For example, in at least one embodiment, the smart contract can input the wager and/or the data indicative of the wager into the queue based at least in part on (e.g., according to) one or more predefined rules. In some embodiments, such one or more predefined rules can be defined by, for example, the entity and/or another entity. For instance, in one example embodiment, the wager can include and/or constitute a plurality of sub-wagers and/or the one or more predefined rules can define details and/or terms (e.g., conditional terms, if-then statements, etc.) that can specify how the entity wants to submit one or more of such sub-wagers to the electronic game. In this example embodiment, the smart contract can facilitate inputting the sub-wager(s) and/or data indicative of the sub-wager(s) into the queue according to such details and/or terms that can specify how the entity wants to submit the sub-wager(s) to the electronic game.

In accordance with at least one embodiment of the present disclosure, based at least in part on inputting the above-described wager, sub-wager(s), and/or data that can be indicative of the wager and/or sub-wager(s) into such a queue, computing system 110 and/or one or more computing devices 112 can provide the entity access to view one or more queue entities in the queue. In some embodiments, such one or more queue entities can include and/or constitute, for instance, data indicative of the wager and/or sub-wager(s) and/or data indicative of one or more second wagers that can also correspond to the electronic game and/or one or more remote gaming devices 150A, 150B, 150N. In these embodiments, such one or more second wagers can be associated with the entity and/or one or more second entities (e.g., a 3^{rd} party entity, another player, etc.). In an example embodiment, computing system 110 and/or one or more computing devices 112 can provide the entity access to view such one or more queue entities on a display (e.g., monitor, screen, etc.) of one or more computing devices 132, local gaming device 160, and/or another computing device.

In one or more embodiments described herein, computing system 110 and/or one or more computing devices 112 can receive (e.g., from one or more remote gaming devices 150A, 150B, 150N) a game play outcome of a game play of the electronic game executed on one or more remote gaming devices 150A, 150B, 150N. In some embodiments, such a game play outcome can include and/or constitute game play outcome data that can result from the execution of the electronic game and/or the game play by one or more remote gaming devices 150A, 150B, 150N. For example, in at least one embodiment, the game play outcome can include and/or constitute: data that can be indicative of the game play outcome (e.g., digital data, analog data, binary data, etc.); data that can be indicative of a game play result (e.g., win, loss, tie, etc.); and/or other data (e.g., metadata, embedded data, scripts, code, etc.) that can be associated with the game play outcome.

In one or more embodiments, the game play outcome can lack supplemental game play content that can be associated with the execution (e.g., by one or more remote gaming devices 150A, 150B, 150N) of the electronic game and/or the game play. In these one or more embodiments, the supplemental game play content that can be lacking from the game play outcome can include, but is not limited to: visual content (e.g., graphical content, graphics, video, images, media content, etc.); audio content (e.g., music, game play instructions, notifications, alarms, etc.); textual content (e.g., textual data, numerical data, alphanumerical data, etc.); and/or other data (e.g., metadata, embedded data, scripts, code, etc.) that can be associated with the execution of the electronic game and/or the game play by one or more remote gaming devices 150A, 150B, 150N. In this way, computing system 110 and/or one or more computing devices 112 can provide the game play outcome to the entity prior to receiving or generating supplemental game play content associated with execution of at least one of the electronic game or game play.

According to one or more embodiments of the present disclosure, computing system 110 and/or one or more computing devices 112 can receive the game play outcome from, for instance, one or more remote gaming devices 150A, 150B, 150N via network 102. In these one or more embodiments, computing system 110 and/or one or more computing devices 112 can receive the game play outcome from, for instance, one or more remote gaming devices 150A, 150B, 150N based at least in part on (e.g., in response to) execution of the electronic game and/or the game play on and/or by one or more remote gaming devices 150A, 150B, 150N.

In at least one embodiment of the present disclosure, computing system 110 and/or one or more computing devices 112 can provide the game play outcome to the entity. For example, in at least one embodiment, the game play outcome can include and/or constitute data that can be indicative of a game play result such as, for instance, data that can be indicative of a win, a loss, a tie, and/or another outcome that can result from execution of the game play. In one or more embodiments, computing system 110 and/or one or more computing devices 112 can provide the game play outcome and/or data that can be indicative of the game play outcome to the entity via, for instance, network 102, one or more computing devices 132, and/or local gaming device 160.

According to one or more embodiments described herein, computing system 110 and/or one or more computing devices 112 can receive game play input data that can used by one or more remote gaming devices 150A, 150B, 150N and/or the electronic game to execute the game play. For instance, in an example embodiment, computing system 110 and/or one or more computing devices 112 can receive game play input data that can used by one or more remote gaming devices 150A, 150B, 150N and/or the electronic game to execute the game play, where the execution of the game play using the game play input data can provide the above-described game play outcome of the game play. In one or more embodiments, computing system 110 and/or one or more computing devices 112 can receive the game play input data before, during, and/or after execution of the game play by one or more remote gaming devices 150A, 150B, 150N and/or the electronic game. For instance, in these one or more embodiments, computing system 110 and/or one or more computing devices 112 can receive the game play input data before runtime, at runtime, during runtime, and/or after runtime of the game play. In one embodiment, computing system 110 and/or one or more computing devices 112 can receive the game play input data from one or more remote gaming devices 150A, 150B, 150N via, for instance, network 102. In another embodiment, computing system 110 and/or one or more computing devices 112 can store the game play input data locally (e.g., on one or more memory devices 116) and/or remotely (e.g., on one or more memory devices 136, a memory device of local gaming device 160, etc.).

In at least one embodiment, the above-described game play input data can include and/or constitute, for instance, a random number that can be generated by a random number generator. For example, in this embodiment, the random number can include and/or constitute a single random number, a sequence of random numbers, a set of random numbers, and/or another random number that can be generated by, for instance, a random number generator. In some embodiments, the random number generator can be included in, coupled to, and/or otherwise associated with one or more remote gaming devices 150A, 150B, 150N. In these embodiments, one or more remote gaming devices 150A, 150B, 150N and/or the electronic game can obtain a random number from the random number generator and can further execute the game play using such a random number to produce the above-described game play outcome of the game play (e.g., the game play outcome lacking supplemental game play content associated with execution of the electronic game and/or the game play).

In one or more embodiments of the present disclosure, one or more remote gaming devices 150A, 150B, 150N can provide the entity and/or another entity (e.g., a 3^{rd} party entity, another player, a regulator entity, etc.) with the random number used to execute the game play and/or generate the corresponding game play outcome produced therefrom, where the game play outcome can lack the above-described supplemental game play content. For example, in one embodiment, based at least in part on receipt of a request from the entity and/or another entity, one or more remote gaming devices 150A, 150B, 150N can provide the random number and/or the corresponding game play outcome. In an example embodiment, one or more remote gaming devices 150A, 150B, 150N can receive such a request and/or provide the random number and/or the game play outcome to the entity and/or another entity via, for instance, network 102, computing system 110, one or more computing devices 112, one or more computing devices 132, and/or local gaming device 160. In another embodiment, one or more remote gaming devices 150A, 150B, 150N can store the random number and/or the game play outcome locally (e.g., on a memory device of one or more remote gaming devices 150A, 150B, 150N) and/or remotely (e.g., one or more memory devices 116, one or more memory devices 136, a memory device of local gaming device 160, etc.).

In accordance with one or more embodiments described herein, computing system 110 and/or one or more computing devices 112 can receive a request from the entity and/or another entity (e.g., a 3^{rd} party entity, another player, a regulator entity, etc.) to view a recreation of the game play, where the recreation can include and/or constitute some or all the above-described supplemental game play content. In these one or more embodiments, computing system 110 and/or one or more computing devices 112 can receive such a request from the entity and/or another entity via, for instance, network 102, one or more computing devices 132, and/or local gaming device 160.

In one or more embodiments of the present disclosure, based at least in part on (e.g., in response to) receipt of such a request from the entity and/or another entity to view a recreation of the game play, computing system 110 and/or one or more computing devices 112 can generate the recreation of the game play based at least in part on (e.g., using) the above-described game play input data. In these one or more embodiments, such a recreation that can be generated by computing system 110 and/or one or more computing devices 112 can include and/or constitute some or all of the supplemental game play content described above. In one embodiment, to facilitate generation of such a recreation by computing system 110 and/or one or more computing devices 112, computing system 110 and/or one or more computing devices 112 can generate some or all of the supplemental game play content described above (e.g., using the above-described game play input data).

In one or more embodiments, based at least in part on (e.g., in response to) receipt of such a request to view a recreation of the game play, computing system 110 and/or one or more computing devices 112 can generate the recreation of the game play using, for instance, a random number that was previously used by one or more remote gaming devices 150A, 150B, 150N and/or the electronic game to execute the game play. In these one or more embodiments, the recreation of the game play can include and/or constitute some or all of the above-described supplemental game play content that can be associated with the execution of the electronic game and/or the game play by, for instance, one or more remote gaming devices 150A, 150B, 150N. In at least one example embodiment, such supplemental game play content can include and/or constitute, for instance: visual content (e.g., graphical content, graphics, video, images, media content, etc.); audio content (e.g., music, game play instructions, notifications, alarms, etc.); textual content (e.g., textual data, numerical data, alphanumerical data, etc.); and/or other data (e.g., metadata, embedded data, scripts, code, etc.) that can be associated with the execution (e.g., by one or more remote gaming devices 150A, 150B, 150N) of the electronic game and/or the game play.

According to one or more embodiments described herein, computing system 110 and/or one or more computing devices 112 can provide such a recreation of the game play to the entity and/or another entity, where the recreation can include and/or constitute some or all of the above-described supplemental game play content that can be associated with the execution of the electronic game and/or the game play. For example, in one or more embodiments of the present disclosure, computing system 110 and/or one or more computing devices 112 can provide (e.g., via network 102) data that can be associated with and/or indicative of the recreation of the game play to one or more computing devices 132 and/or local gaming device 160. In these one or more embodiments, such data that can be associated with and/or indicative of the recreation can include and/or constitute some or all of the above-described supplemental game play content.

In at least one example embodiment, computing system 110 and/or one or more computing devices 112 can provide the recreation of the game play, and/or the data that can be associated therewith and/or indicative thereof, to one or more computing devices that can be associated with the entity and/or another entity, where such computing device(s) can include and/or constitute, for instance, one or more computing devices 132, one or more remote gaming devices 150A, 150B, 150N, and/or local gaming device 160. In this example embodiment, computing system 110 and/or one or more computing devices 112 can provide such a recreation of the game play, and/or the data that can be associated therewith and/or indicative thereof, to such computing device(s) that can be associated with the entity and/or another entity via, for instance, network 102.

In one or more embodiments described herein, computing system 110 and/or one or more computing devices 112 can record one or more events associated with the wager on a blockchain. In at least one embodiment described herein, computing system 110 and/or one or more computing devices 112 can use the above-described smart contract that can be associated with at least the wager and/or the entity to record on a blockchain such one or more events based at least in part on (e.g., according to) one or more predefined rules. In at least one embodiment, the one or more predefined rules can be defined by, for instance, the entity and/or another entity. In some embodiments, the one or more predefined rules can define details and/or terms (e.g., conditional terms, if-then statements, etc.) that can specify, for instance: the one or more events associated with the wager that the entity wants to record on a blockchain; the blockchain(s) on which the entity wants to record the one or more events associated with the wager; and/or another detail and/or term. In these embodiments, the smart contract can facilitate recording on a blockchain(s) the one or more events associated with the wager according to such details and/or terms that can specify the criteria for recording such one or more events on the blockchain(s).

According to at least one embodiment of the present disclosure, the one or more events that can be recorded on a blockchain by computing system 110 and/or one or more computing devices 112 can include, but are not limited to, for instance: one or more life cycle events associated with the wager (e.g., creation, termination, etc.); one or more transactions associated with the wager (e.g., submittal of the wager to one or more remote gaming devices 150A, 150B, 150N and/or the electronic game, transfer of ownership of the wager, return of wager resulting from a game play win associated with the wager, loss of the wager resulting from a game play loss associated with the wager, etc.); one or more monetary transactions associated with application of the wager (e.g., transfer of currency associated with submittal of the wager to one or more remote gaming devices 150A, 150B, 150N and/or the electronic game, transfer of currency won resulting from a game play win associated with the wager, transfer of currency lost resulting from a game play loss associated with the wager, etc.); and/or another event associated with the wager.

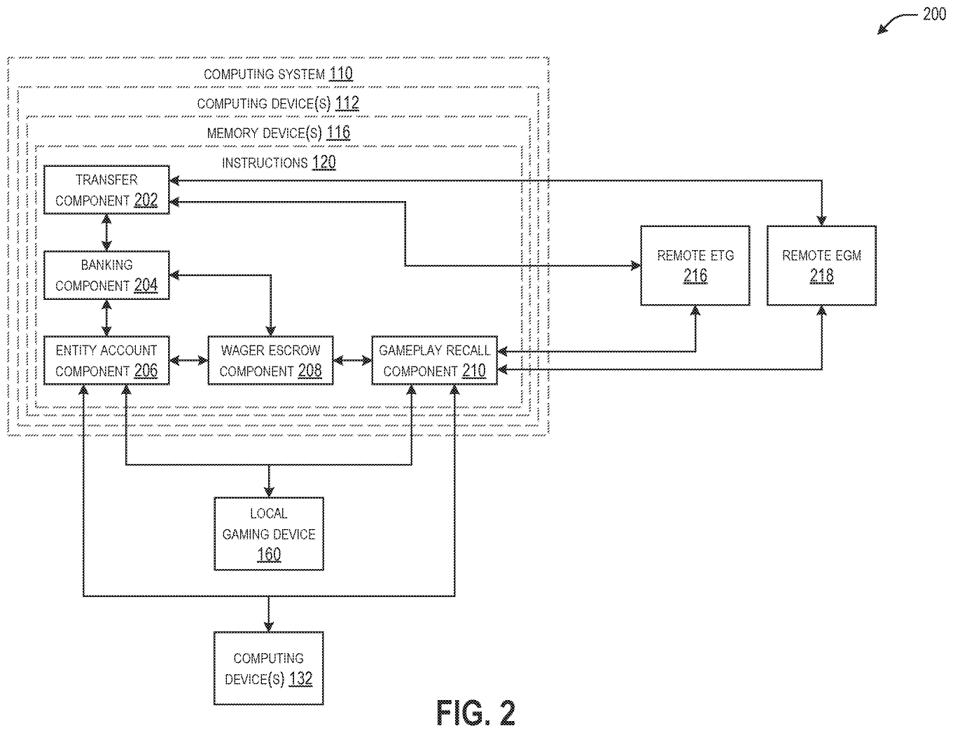

FIG. 2 illustrates a block diagram of an example, non-limiting electronic gaming system 200 that can facilitate remote execution of a game play according to example embodiments of the present disclosure. Electronic gaming system 200 according to at least one embodiment of the present disclosure can include and/or constitute an example, non-limiting alternative embodiment of electronic gaming system 100 described above with reference to FIG. 1.

In at least one example embodiment, FIG. 2 illustrates a data flow diagram depicting data flow between various components, systems, devices, and/or machines of electronic gaming system 200. In this example embodiment, such data flow can include and/or constitute data flow associated with one or more communications and/or operations that can be performed by and/or otherwise associated with any of such components, systems, devices, and/or machines of electronic gaming system 200. In the example embodiment depicted in FIG. 2, such one or more communications can be performed via, for instance, network 102, which is not illustrated in FIG. 2 for purposes of clarity.

As illustrated in the example embodiment depicted in FIG. 2, instructions 120 of electronic gaming system 100 and/or electronic gaming system 200 can include a transfer component 202, a banking component 204, an entity account component 206, a wager escrow component 208, and/or a gameplay recall component 210. In the example embodiment depicted in FIG. 2, computing system 110, one or more computing devices 112, and/or one or more components of instructions 120 (e.g., transfer component 202, entity account component 206, and/or gameplay recall component 210) can communicate with a remote electronic table game 216 (denoted as “REMOTE ETG 216” in FIG. 2), a remote electronic gaming machine 218 (denoted as “REMOTE EGM 218” in FIG. 2), one or more computing devices 132, and/or local gaming device 160. In one example embodiment, computing system 110, one or more computing devices 112, and/or transfer component 202 can include and/or be coupled to one or more transfer adapters (not illustrated in FIG. 2) that can facilitate communication with remote electronic table game 216 and/or remote electronic gaming machine 218.

In one embodiment, remote electronic table game 216 and/or remote electronic gaming machine 218 can respectively constitute one or more remote gaming devices 150A, 150B, 150N described above with reference to FIG. 1. In another embodiment, remote electronic table game 216 and/or remote electronic gaming machine 218 can respectively include any of the attributes and/or capabilities of one or more remote gaming devices 150A, 150B, 150N described above with reference to FIG. 1. In one or more embodiments, remote electronic table game 216 and/or remote electronic gaming machine 218 can respectively execute one or more electronic games and/or one or more game plays that can generate the above-described game play outcome lacking the supplemental game play content described above.

In at least one embodiment described herein, transfer component 202, banking component 204, entity account component 206, wager escrow component 208, and/or gameplay recall component 210 can respectively include and/or constitute machine-readable and/or computer-readable instructions and/or commands (e.g., application software) that, when executed by one or more of the components, systems, devices, and/or machines of electronic gaming system 100 and/or electronic gaming environment 200 described herein can cause such one or more components, systems, devices, and/or machines to perform one or more operations in accordance with one or more embodiments of the present disclosure. In one or more embodiments, such one or more operations can include and/or constitute any of the operations described above with reference to FIG. 1 and/or described here with reference to FIG. 2 that can be performed by and/or otherwise associated with computing system 110, one or more computing devices 112, one or more computing devices 132, one or more remote gaming devices 150A, 150B, 150N, local gaming device 160, remote electronic table game 216, and/or remote electronic gaming machine 218.

In the example embodiment illustrated in FIG. 2, entity account component 206 can include, constitute, and/or function as an entity account services component. For example, in this embodiment, entity account component 206 can include, constitute, and/or function as an entry point that allows an entity to implement one or more aspects of electronic gaming system 100 and/or electronic gaming system 200 in accordance with one or more embodiments described herein. In some embodiments, entity account component 206 can be included in instructions 140 of one or more computing devices 132 and/or included in instructions of local gaming device 160. In one or more embodiments, entity account component 206 allows an entity to input data and/or information (e.g., wagers, choice selections, etc.) into computing system 110 and/or one or more computing devices 112 and/or to create an account (e.g., a gaming account) associated with the entity, electronic gaming system 100, computing system 110, one or more computing devices 112, and/or electronic gaming system 200. In at least one embodiment, entity account component 206 can facilitate activation of one or more wagers input by an entity, for example, when such an entity is located at a wagering establishment (e.g., a casino) and/or using a device (e.g., one or more computing devices 132, local gaming device 160, etc.) at a location where gambling is legal.

In the example embodiment depicted in FIG. 2, wager escrow component 208 can include, constitute, and/or function as an entity wager escrow services component. In this embodiment, wager escrow component 208 can facilitate execution of one or more operations (e.g., wager management, escrow operations, etc.) associated with a wager input by an entity in accordance with one or more embodiments described herein. For example, wager escrow component 208 can facilitate execution of one or more operations described above with reference to FIG. 1 in relation to associating at least the wager and/or the entity with a smart contract and/or using the smart contract to perform at least one of execution, control, or documentation (e.g., on a blockchain) of one or more events associated with the wager (e.g., according to one or more predefined rules that can be defined by, for instance, the entity via, for example, entity account component 206).

In the example embodiment depicted in FIG. 2, banking component 204 can include, constitute, and/or function as a banking services component. In this embodiment, banking component 204 can execute fiduciary responsibilities associated with at least one of an entity and/or one or more wagers input by the entity. For example, banking component 204 can execute fiduciary responsibilities associated with funding and/or defunding (e.g., with real currency, virtual currency, crypto currency, etc.) the entity's gaming account (e.g., via entity account component 206) in connection with one or more wagers input by the entity.

In the example embodiment depicted in FIG. 2, transfer component 202 can include, constitute, and/or function as a transfer services component. In this embodiment, transfer component 202 can add, remove, and/or queue (e.g., according to one or more smart contract terms) one or more entity wagers and/or credits associated with execution of one or more electronic games and/or game plays by remote electronic table game 216 and/or remote electronic gaming machine 218. In the embodiment, to facilitate such operations, transfer component 202 can employ one or more transfer adapters to communicate with remote electronic table game 216 and/or remote electronic gaming machine 218 using one or more approved communication protocols (e.g., protection and/or encryption protocols described above with reference to FIG. 1).

In the example embodiment depicted in FIG. 2, gameplay recall component 210 can include, constitute, and/or function as a gameplay recall service component. In this embodiment, gameplay recall component 210 can process gameplay feed (e.g., the above-described game play outcome lacking supplemental game play content) received from remote electronic table game 216 and/or remote electronic gaming machine 218 based at least in part on execution of an electronic game and/or a game play by remote electronic table game 216 and/or remote electronic gaming machine 218. In this embodiment, gameplay recall component 210 can format such gameplay feed such that it can be provided to and/or rendered on one or more display devices of, for instance, one or more computing devices 132, one or more remote gaming devices 150A, 150B, 150N, and/or local gaming device 160.

It should be appreciated that an entity that implements electronic gaming system 100 and/or electronic gaming system 200 in accordance with one or more embodiments described herein can register with entity account component 206 to participate (e.g., place one or more wagers) in one or more electronic games and/or game plays to be executed by one or more remote gaming devices 150A, 150B, 150N, remote electronic table game 216, and/or remote electronic gaming machine 218. In these one or more embodiments, the entity can view live (e.g., real-time, current) content at a participating local wagering establishment (e.g., a casino) via one or more computing devices 132 and/or local gaming device 160, where such live content can be provided by one or more participating remote gaming devices such as, for instance, one or more remote gaming devices 150A, 150B, 150N, remote electronic table game 216, and/or remote electronic gaming machine 218. In these one or more embodiments, such live content can be provided to one or more computing devices 132 and/or local gaming device 160 via computing system 110 and/or one or more computing devices 112 wherever permitted (e.g., at geographical locations where gambling is legal and permitted). In these one or more embodiments, the entity can use one or more computing devices 132 and/or local gaming device 160 to input one or more wagers into computing system 110 and/or one or more computing devices 112, where such one or more wagers can correspond to one or more electronic games and/or game plays to be executed on one or more remote gaming devices 150A, 150B, 150N, remote electronic table game 216, and/or remote electronic gaming machine 218.

In the above one or more embodiments, the entity can use one or more computing devices 132 and/or local gaming device 160 to select one or more remote gaming devices (e.g., one or more remote gaming devices 150A, 150B, 150N, remote electronic table game 216, and/or remote electronic gaming machine 218) that will execute such electronic game(s) and/or game play(s). In these one or more embodiments, the entity can commit and/or associate one or more wagers (e.g., credits) to such one or more remote gaming devices that will execute such electronic game(s) and/or game play(s). In these one or more embodiments, based at least in part on (e.g., in response to) execution of an electronic game and/or a game play thereof, by such one or more remote gaming devices, computing system 110 and/or one or more computing devices 112 can employ gameplay recall component 210 to provide a game play outcome and/or a recreation of a game play to the entity via one or more computing devices 132 and/or local gaming device 160. For example, computing system 110 and/or one or more computing devices 112 can employ gameplay recall component 210 to provide a game play outcome as a screen shot of the outcome and/or a recreation of an entire game play to the entity via one or more computing devices 132 and/or local gaming device 160. In these one or more embodiments, such one or more remote gaming devices (e.g., one or more remote gaming devices 150A, 150B, 150N, remote electronic table game 216, and/or remote electronic gaming machine 218) can perform the game play as normal and/or at a relatively high rate of play. In these one or more embodiments, the entity wager(s) and/or credit(s) can be transferred for play by transfer component 202, which can maintain a queue on behalf of a plurality of entities including the entity. In these one or more embodiments, game plays can be executed by such one or more remote gaming devices in the order received.

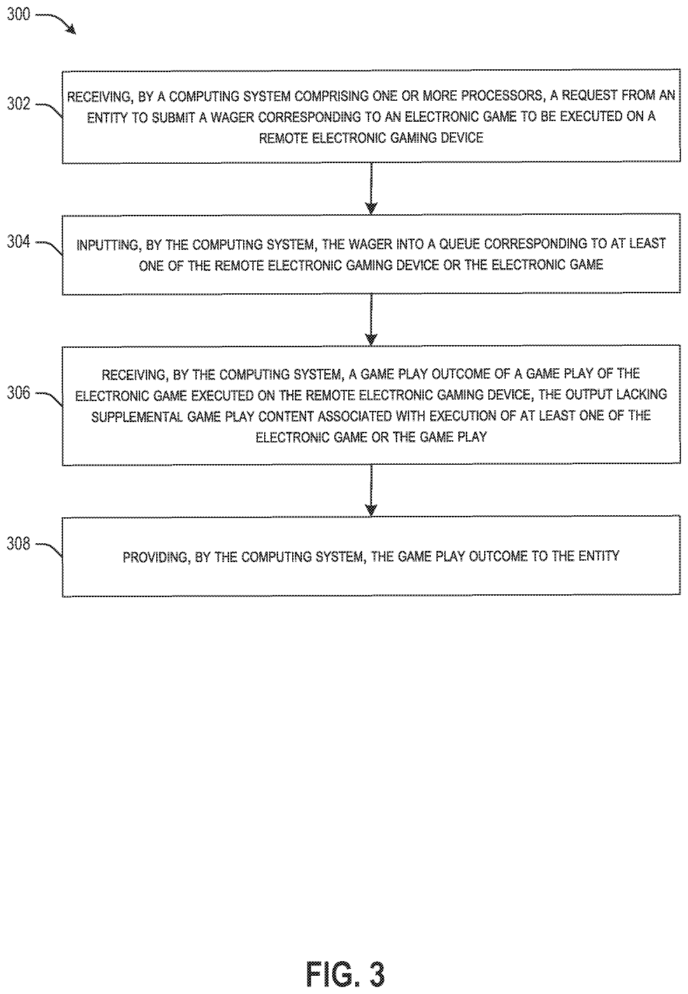

FIG. 3 illustrates a flow diagram of an example, non-limiting computer-implemented method 300 that can facilitate remote execution of a game play according to example embodiments of the present disclosure. In one or more embodiments of the present disclosure, one or more portions of computer-implemented method 300 can be executed and/or implemented by one or more computing systems and/or computing devices including, for example, computing system 110 and/or one or more computing devices 112. Further, in these one or more embodiments, one or more portions of computer-implemented method 300 can be executed and/or implemented as an algorithm and/or as machine-readable instructions (e.g., computer software) using, for instance, one or more hardware components of one or more devices and/or systems disclosed herein.

The example embodiment illustrated in FIG. 3 depicts steps performed in a particular order for purposes of illustration and discussion. However, those of ordinary skill in the art, using the disclosures provided herein, will understand that various steps of computer-implemented method 300 and/or any other methods disclosed herein can be adapted, combined, modified, rearranged, omitted, and/or expanded without deviating from the scope of the present disclosure.

At 302, computer-implemented method 300 can include receiving, by a computing system (e.g., computing system 110 and/or one or more computing devices 112) operatively coupled to one or more processors (e.g., one or more processors 114), a request from an entity to submit a wager corresponding to an electronic game to be executed on a remote electronic gaming device (e.g., one or more remote gaming devices 150A, 150B, 150N, gaming machine 500, electronic gaming machine 601, one or more gaming machines 803, etc.).

At 304, computer-implemented method 300 can include inputting, by the computing system (e.g., computing system 110 and/or one or more computing devices 112) the wager into a queue corresponding to at least one of the remote electronic gaming device or the electronic game.

At 306, computer-implemented method 300 can include receiving, by the computing system (e.g., computing system 110 and/or one or more computing devices 112) a game play outcome of a game play of the electronic game executed on the remote electronic gaming device. In one or more embodiments, the game play outcome can lack supplemental game play content associated with execution of at least one of the electronic game or the game play.

At 308, computer-implemented method 300 can include providing, by the computing system (e.g., computing system 110 and/or one or more computing devices 112) the game play outcome to the entity. In some embodiments, computer-implemented method 300 can include providing, by the computing system, the game play outcome to the entity prior to receiving or generating supplemental game play content associated with execution of at least one of the electronic game or the game play.

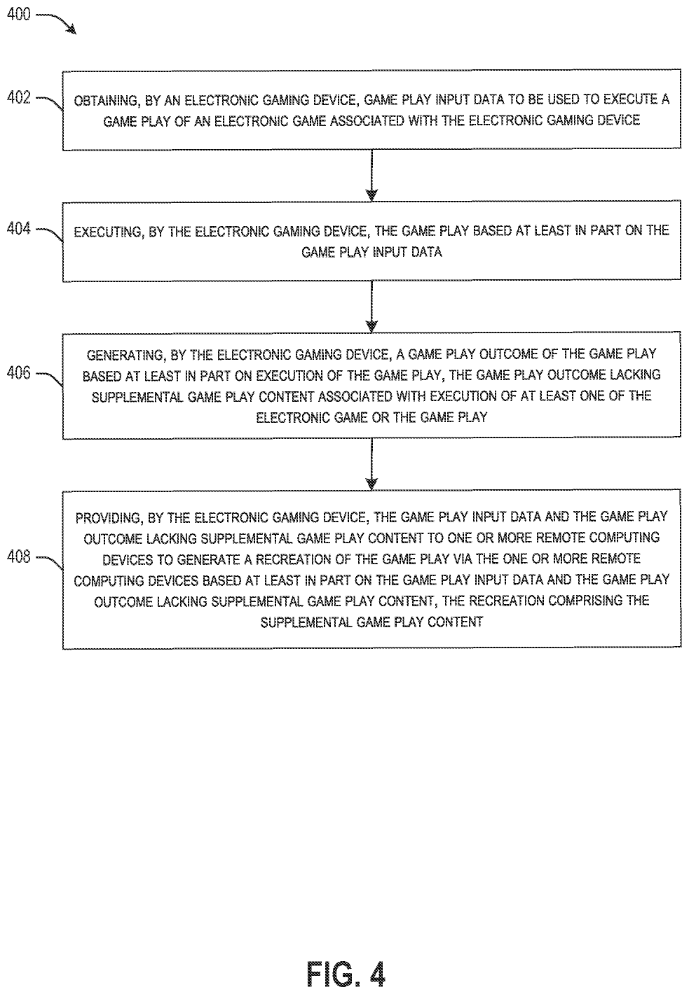

FIG. 4 illustrates a flow diagram of an example, non-limiting computer-implemented method 400 that can facilitate remote execution of a game play according to example embodiments of the present disclosure. In one or more embodiments of the present disclosure, one or more portions of computer-implemented method 400 can be executed and/or implemented by one or more computing systems and/or computing devices including, for example, one or more remote gaming devices 150A, 150B, 150N, gaming machine 500, electronic gaming machine 601, and/or one or more gaming machines 803. Further, in these one or more embodiments, one or more portions of computer-implemented method 400 can be executed and/or implemented as an algorithm and/or as machine-readable instructions (e.g., computer software) using, for instance, one or more hardware components of one or more devices and/or systems disclosed herein.

The example embodiment illustrated in FIG. 4 depicts steps performed in a particular order for purposes of illustration and discussion. However, those of ordinary skill in the art, using the disclosures provided herein, will understand that various steps of computer-implemented method 400 and/or any other methods disclosed herein can be adapted, combined, modified, rearranged, omitted, and/or expanded without deviating from the scope of the present disclosure.

At 402, computer-implemented method 400 can include obtaining, by an electronic gaming device (e.g., by one or more remote gaming devices 150A, 150B, 150N, gaming machine 500, electronic gaming machine 601, and/or one or more gaming machines 803) operatively coupled to one or more processors (e.g., one or more processors respectively included in and/or coupled to one or more remote gaming devices 150A, 150B, 150N, gaming machine 500, electronic gaming machine 601, and/or gaming machines 803), game play input data (e.g., a random number) to be used to execute a game play of an electronic game associated with the electronic gaming device.

At 404, computer-implemented method 400 can include executing, by the electronic gaming device (e.g., by one or more remote gaming devices 150A, 150B, 150N, gaming machine 500, electronic gaming machine 601, and/or one or more gaming machines 803), the game play based at least in part on (e.g., using) the game play input data.

At 406, computer-implemented method 400 can include generating, by the electronic gaming device (e.g., by one or more remote gaming devices 150A, 150B, 150N, gaming machine 500, electronic gaming machine 601, and/or one or more gaming machines 803), a game play outcome of the game play based at least in part on execution of the game play, the game play outcome lacking supplemental game play content associated with execution of at least one of the electronic game or the game play.

At 408, computer-implemented method 400 can include providing, by the electronic gaming device (e.g., by one or more remote gaming devices 150A, 150B, 150N, gaming machine 500, electronic gaming machine 601, and/or one or more gaming machines 803), the game play input data and the game play outcome lacking supplemental game play content to one or more remote computing devices to generate a recreation of the game play via the one or more remote computing devices based at least in part on the game play input data and the game play outcome lacking supplemental game play content, the recreation comprising the supplemental game play content.

The following figures and description provide an example architecture for the foregoing systems. It is to be understood, however, that the following figures and description are for exemplary purposes only and that other suitable architectures may be used. Referring to FIG. 5, gaming machine 500 capable of supporting various embodiments of the invention is shown, including cabinet housing 520, primary game display 540 upon which a primary game and feature game may be displayed, top box 550 which may display multiple progressives that may be won during play of the feature game, player-activated buttons 560, player tracking panel 536, bill/voucher acceptor 580 and one or more speakers 590. Cabinet housing 520 may be a self-standing unit that is generally rectangular in shape and may be manufactured with reinforced steel or other rigid materials which are resistant to tampering and vandalism. Cabinet housing 520 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 500 or thin client capability such as that incorporating some of the capability of a remote server. Exemplary types of gaming machines are disclosed in U.S. Pat. Nos. 6,517,433, 8,057,303, and 8,226,459, which are incorporated herein by reference in their entireties.

In one or more embodiments, cabinet housing 520 houses a processor, circuitry, and software (not shown) for receiving signals from the player-activated buttons 560, operating the games, and transmitting signals to the respective displays and speakers. Any shaped cabinet may be implemented with any embodiment of gaming machine 500 so long as it provides access to a player for playing a game. For example, cabinet 520 may comprise a slant-top, bar-top, or table-top style cabinet, including a Bally Cinevision™ or CineReels™ cabinet. The operation of gaming machine 500 is described more fully below.

The plurality of player-activated buttons 560 may be used for various functions such as, but not limited to, selecting a wager denomination, selecting a game to be played, selecting a wager amount per game, initiating a game, or cashing out money from gaming machine. Buttons 560 may be operable as input mechanisms and may include mechanical buttons, electromechanical buttons or touch screen buttons. Optionally, a handle 585 may be rotated by a player to initiate a game.

In one or more embodiments, buttons 560 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. Pat. App. Publication No. 2006/0247047, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 520 may optionally include top box 550 which contains “top glass” 552 comprising advertising or payout information related to the game or games available on gaming machine 500. Player tracking panel 536 includes player tracking card reader 534 and player tracking display 532. Voucher printer 530 may be integrated into player tracking panel 536 or installed elsewhere in cabinet housing 520 or top box 550.

Game display 540 may present a game of chance wherein a player receives one or more outcomes from a set of potential outcomes. For example, one such game of chance is a video slot machine game. In other aspects of the invention, gaming machine 500 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 540 is, typically, a CRT or a flat-panel display in the form of, but not limited to, liquid crystal, plasma, electroluminescent, vacuum fluorescent, field emission, or any other type of panel display known or developed in the art. Game display 540 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 540 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 540 may also present information such as, but not limited to, player information, advertisements and casino promotions, graphic displays, news and sports updates, or even offer an alternate game. This information may be generated through a host computer networked with gaming machine 500 on its own initiative or it may be obtained by request of the player using either one or more of the plurality of player-activated buttons 560; the game display itself, if game display 540 comprises a touch screen or similar technology; buttons (not shown) mounted about game display 540 which may permit selections such as those found on an ATM machine, where legends on the screen are associated with respective selecting buttons; or any player input device that offers the required functionality.

Cabinet housing 520 incorporates a single game display 540. However, in alternate embodiments, cabinet housing 520 or top box 550 may house one or more additional displays 553 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

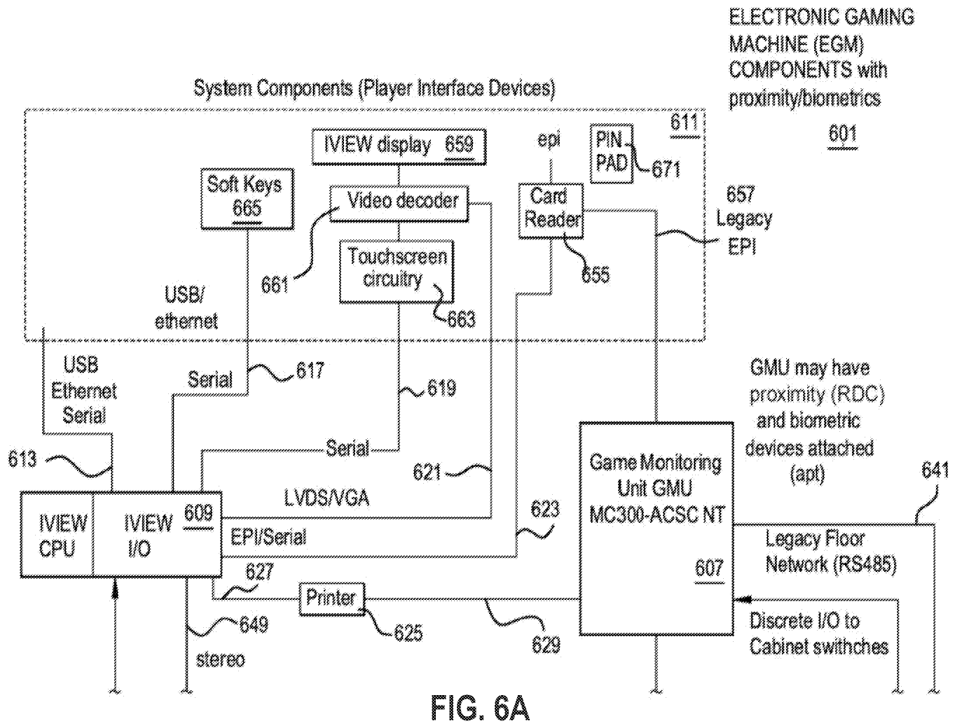

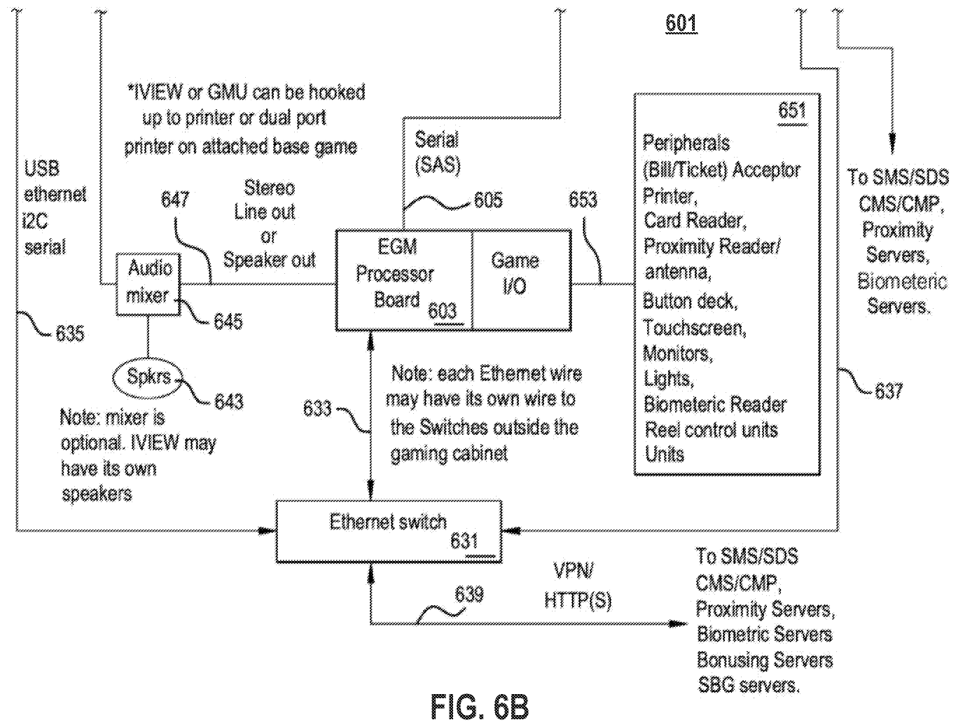

Referring to FIGS. 6A and 6B, electronic gaming machine 601 is shown in accordance with one or more embodiments. Electronic gaming machine 601 includes base game integrated circuit board 603 (EGM Processor Board) connected through serial bus line 605 to game monitoring unit (GMU) 1507 (such as a Bally MC300 or ACSC NT), and player interface integrated circuit board (PIB) 609 connected to player interface devices 611 over bus lines 613, 615, 617, 619, 621, 623. Printer 625 is connected to PM 609 and GMU 607 over bus lines 627, 629. Base game integrated circuit board 603, PIB 609, and GMU 607 connect to Ethernet switch 631 over bus lines 633, 635, 637. Ethernet switch 631 connects to a slot management system (SMS) and a casino management system (CMS) network over bus line 639. GMU 607 also may connect to the SMS and CMS network over bus line 641. Speakers 643 connect through audio mixer 645 and bus lines 647, 649 to base game integrated circuit board 603 and PIB 609. The proximity and biometric devices and circuitry may be installed by upgrading a commercially available PIB 609, such as a Bally iView unit. Coding executed on base game integrated circuit board 603, PIB 609, and/or GMU 607 may be upgraded to integrate a game according to one or more embodiments of the present invention, as is more fully described herein.

Peripherals 651 connect through I/O board 653 to base game integrated circuit board 603. For example, a bill/ticket acceptor is typically connected to a game input-output board 653 which is, in turn, connected to a conventional central processing unit (“CPU”) base game integrated circuit board 603, such as an Intel Pentium microprocessor mounted on a gaming motherboard. I/O board 653 may be connected to base game integrated circuit board 603 by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. Base game integrated circuit board 603 executes a game program that causes base game integrated circuit board 603 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 653 to base game integrated circuit board 603 which, in turn, assigns an appropriate number of credits for play in accordance with the game program. The player may further control the operation of the gaming machine by way of other peripherals 651, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 600; for example, it may be part of a central determination host system which provides random game outcomes to the game program. Thereafter, the player may or may not interact with the game through electromechanical or touch screen buttons to change the displayed indicia. Finally, base game integrated circuit board 603 under control of the game program and OS compares the final display of indicia to a pay table. The set of possible game outcomes may include a subset of outcomes related to the triggering of a feature game. In the event the displayed outcome is a member of this subset, base game integrated circuit board 603, under control of the game program and by way of I/O Board 653, may cause feature game play to be presented on a feature display.

Predetermined payout amounts for certain outcomes, including feature game outcomes, are stored as part of the game program. Such payout amounts are, in response to instructions from base game integrated circuit board 603, provided to the player in the form of coins, credits or currency via I/O board 653 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to random access memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 607 includes an integrated circuit board and GMU processor and memory including coding for network communications, such as the G2S (game-to-system) protocol from the Gaming Standards Association, Las Vegas, Nev., used for system communications over the network. As shown, GMU 607 may connect to card reader 655 through bus 657 and may thereby obtain player card information and transmit the information over the network through bus 641. Gaming activity information may be transferred by the base game integrated circuit board 603 to GMU 607 where the information may be translated into a network protocol, such as S2S, for transmission to a server, such as a player tracking server, where information about a player's playing activity may be stored in a designated server database.

PIB 609 includes an integrated circuit board, PID processor, and memory which includes an operating system, such as Windows CE, a player interface program which may be executable by the PID processor together with various input/output (I/O) drivers for respective devices which connect to PIB 609, such as player interface devices 611, and which may further include various games or game components playable on PIB 609 or playable on a connected network server and PIB 609 is operable as the player interface. PIB 609 connects to card reader 655 through bus 623, display 659 through video decoder 661 and bus 621, such as an LVDS or VGA bus.

As part of its programming, the PID processor executes coding to drive display 659 and provide messages and information to a player. Touch screen circuitry interactively connects display 659 and video decoder 661 to PIB 609, such that a player may input information and cause the information to be transmitted to PM 609 either on the player's initiative or responsive to a query by PIB 609. Additionally soft keys 665 connect through bus 617 to PM 609 and operate together with display 659 to provide information or queries to a player and receive responses or queries from the player. PIB 609, in turn, communicates over the CMS/SMS network through Ethernet switch 631 and busses 635, 639 and with respective servers, such as a player tracking server.

Player interface devices 611 are linked into the virtual private network of the system components in gaming machine 601. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to install on the system components.

The system components include the iView processing board and game monitoring unit (GMU) processing board. The GMU and iView can be combined into one like the commercially available Bally GTM iView device. This device may have a video mixing technology to mix the EGM processor's video signals with the iView display onto the top box monitor or any monitor on the gaming device.

In the example embodiment, GMU 607 and/or PIB 609 are configured to transmit and receive data with a management computing device (not shown). In particular, GMU 607 and/or PIB 609 may transmit messages indicating the operational state, status, events and/or other data associated with the gaming machine to the management computing device 106, and the management computing device 106 may transmits commands, such as operational state commands, and/or other data to GMU 607 and/or PIB 609. These commands are in a data format recognized by GMU 607 and/or PIB 609 and cause GMU 607 and/or PIB 609 to execute instruction to facilitate an operational state transition. The operational state transition may include selectively enabling, disabling, or otherwise changing operation of hardware and/or software of the gaming machine. In one example, input devices such as the soft keys 665 may be disabled. In another example, the card reader 655 may accept cards, but the card data may not be read or transmitted to networked server systems.

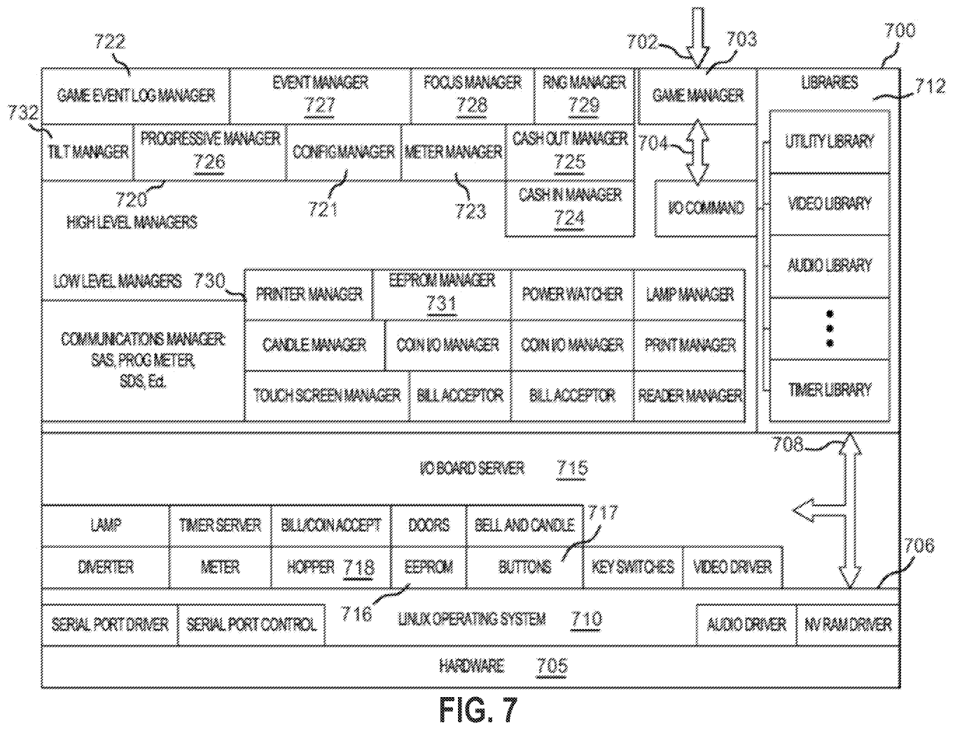

In accordance with one or more embodiments, FIG. 7 is a functional block diagram of a gaming kernel 700 of a game program under control of base game integrated circuit board 603. The game program uses gaming kernel 700 by calling into application programming interface (API) 702, which is part of game manager 703. The components of game kernel 700 as shown in FIG. 7 are only illustrative, and should not be considered limiting. For example, the number of managers may be changed, additional managers may be added or some managers may be removed without deviating from the scope and spirit of the invention.

As shown in the example, there are three layers: a hardware layer 705; an operating system layer 710, such as, but not limited to, Linux; and a game kernel layer 700 having game manager 703 therein. The operational states of a gaming machine may be defined by one or more parameters over the three layers. As a result, the enable and disable commands may change, disable, or enable these parameters accordingly. In one or more embodiments, the use of a standard operating system 710, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 700 executes at the user level of the operating system 710, and itself contains a major component called the I/O Board Server 715. To properly set the bounds of game application software (making integrity checking easier), all game applications interact with gaming kernel 700 using a single API 702 in game manager 703. This enables game applications to make use of a well-defined, consistent interface, as well as making access points to gaming kernel 700 controlled, where overall access is controlled using separate processes.

For example, game manager 703 parses an incoming command stream and, when a command dealing with I/O comes in (arrow 704), the command is sent to an applicable library routine 712. Library routine 712 decides what it needs from a device, and sends commands to I/O Board Server 715 (see arrow 708). A few specific drivers remain in operating system 710's kernel, shown as those below line 706. These are built-in, primitive, or privileged drivers that are (i) general (ii) kept to a minimum and (iii) are easier to leave than extract. In such cases, the low-level communications is handled within operating system 710 and the contents passed to library routines 712.

Thus, in a few cases library routines may interact with drivers inside operating system 710, which is why arrow 708 is shown as having three directions (between library utilities 712 and I/O Board Server 715, or between library utilities 712 and certain drivers in operating system 710). No matter which path is taken, the logic needed to work with each device is coded into modules in the user layer of the diagram. Operating system 710 is kept as simple, stripped down, and common across as many hardware platforms as possible. The library utilities and user-level drivers change as dictated by the game cabinet or game machine in which it will run. Thus, each game cabinet or game machine may have an base game integrated circuit board 603 connected to a unique, relatively dumb, and as inexpensive as possible I/O adapter board 640, plus a gaming kernel 700 which will have the game-machine-unique library routines and I/O Board Server 715 components needed to enable game applications to interact with the gaming machine cabinet. Note that these differences are invisible to the game application software with the exception of certain functional differences (i.e., if a gaming cabinet has stereo sound, the game application will be able make use of API 702 to use the capability over that of a cabinet having traditional monaural sound).

Game manager 703 provides an interface into game kernel 700, providing consistent, predictable, and backwards compatible calling methods, syntax, and capabilities by way of game application API 702. This enables the game developer to be free of dealing directly with the hardware, including the freedom to not have to deal with low-level drivers as well as the freedom to not have to program lower level managers 730, although lower level managers may be accessible through game manager 703's interface 702 if a programmer has the need. In addition to the freedom derived from not having to deal with the hardware level drivers and the freedom of having consistent, callable, object-oriented interfaces to software managers of those components (drivers), game manager 703 provides access to a set of upper level managers 720 also having the advantages of consistent callable, object-oriented interfaces, and further providing the types and kinds of base functionality required in casino-type games. Game manager 703, providing all the advantages of its consistent and richly functional interface 702 as supported by the rest of game kernel 700, thus provides a game developer with a multitude of advantages.

Game manager 703 may have several objects within itself, including an initialization object (not shown). The initialization object performs the initialization of the entire game machine, including other objects, after game manager 703 has started its internal objects and servers in appropriate order. In order to carry out this function, the kernel's configuration manager 721 is among the first objects to be started; configuration manager 721 has data needed to initialize and correctly configure other objects or servers.

The upper level managers 720 of game kernel 700 may include game event log manager 722 which provides, at the least, a logging or logger base class, enabling other logging objects to be derived from this base object. The logger object is a generic logger; that is, it is not aware of the contents of logged messages and events. The log manager's (722) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 723 manages the various meters embodied in the game kernel 700. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 723 receives its initialization data for the meters, during start-up, from configuration manager 721. While running, the cash in (724) and cash out (725) managers call the meter manager's (723) update functions to update the meters. Meter manager 723 will, on occasion, create backup copies of the soft meters by storing the soft meters' readings in EEPROM. This is accomplished by calling and using EEPROM manager 731.

In accordance with still other embodiments, progressive manager 726 manages progressive games playable from the game machine. Event manager 727 is generic, like log manager 722, and is used to manage various gaming machine events. Focus manager 728 correlates which process has control of various focus items. Tilt manager 732 is an object that receives a list of errors (if any) from configuration manager 721 at initialization, and during game play from processes, managers, drivers, etc. that may generate errors. Random number generator manager 729 is provided to allow easy programming access to a random number generator (RNG), as a RNG is required in virtually all casino-style (gambling) games. RNG manager 729 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 725 has the responsibility of configuring and managing monetary output devices. During initialization, cash out manager 725, using data from configuration manager 721, sets the cash out devices correctly and selects any selectable cash out denominations. During play, a game application may post a cash out event through the event manager 727 (the same way all events are handled), and using a call-back posted by cash out manager 725, cash out manager 725 is informed of the event. Cash out manager 725 updates the credit object, updates its state in non-volatile memory, and sends an appropriate control message to the device manager that corresponds to the dispensing device. As the device dispenses dispensable media, there will typically be event messages being sent back and forth between the device and cash out manager 725 until the dispensing finishes, after which cash out manager 725, having updated the credit manager and any other game state (such as some associated with meter manager 723) that needs to be updated for this set of actions, sends a cash out completion event to event manager 727 and to the game application thereby. Cash in manager 724 functions similarly to cash out manager 725, only controlling, interfacing with, and taking care of actions associated with cashing in events, cash in devices, and associated meters and crediting.

In a further example, in accordance with one or more embodiments, I/O server 715 may write data to the gaming machine EEPROM memory, which is located in the gaming machine cabinet and holds meter storage that must be kept even in the event of power failure. Game manager 703 calls the I/O library functions to write data to the EEPROM. The I/O server 715 receives the request and starts a low priority EEPROM thread 716 within I/O server 715 to write the data. This thread uses a sequence of 8 bit command and data writes to the EEPROM device to write the appropriate data in the proper location within the device. Any errors detected will be sent as IPC messages to game manager 703. All of this processing is asynchronous.

In accordance with one embodiment, button module 717 within I/O server 715, polls (or is sent) the state of buttons every 2 ms. These inputs are debounced by keeping a history of input samples. Certain sequences of samples are required to detect a button was pressed, in which case the I/O server 715 sends an inter-process communication event to game manager 703 that a button was pressed or released. In some embodiments, the gaming machine may have intelligent distributed I/O which debounces the buttons, in which case button module 717 may be able to communicate with the remote intelligent button processor to get the button events and simply relay them to game manager 703 via IPC messages. In still another embodiment, the I/O library may be used for pay out requests from the game application. For example, hopper module 718 must start the hopper motor, constantly monitor the coin sensing lines of the hopper, debounce them, and send an IPC message to the game manager 703 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

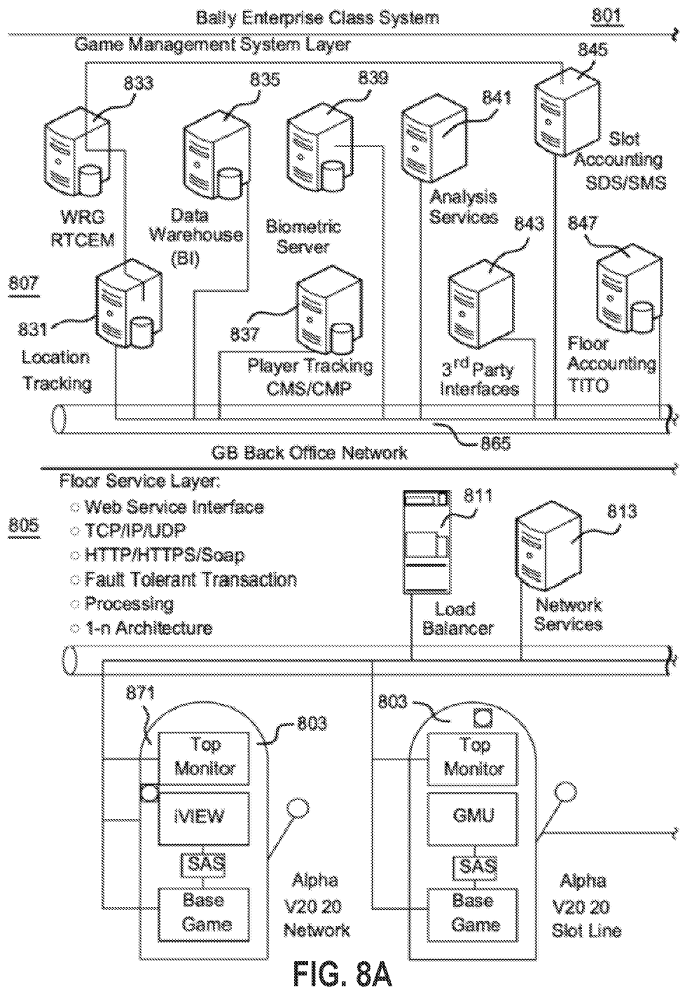

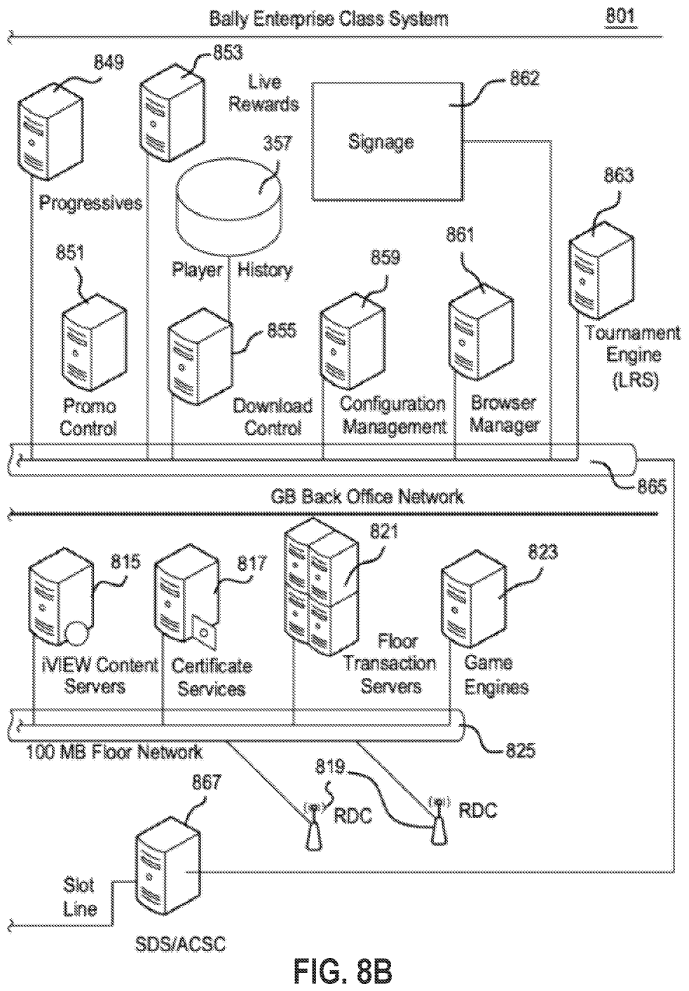

Referring to FIGS. 8A and 8B, enterprise gaming system 801 is shown in accordance with one or more embodiments. Enterprise gaming system 801 may include one casino or multiple locations and generally includes a network of gaming machines 803, floor management system (SMS) 805, and casino management system (CMS) 807. SMS 805 may include load balancer 811, network services servers 813, player interface (iView) content servers 815, certificate services server 817, floor radio dispatch receiver/transmitters (RDC) 819, floor transaction servers 821 and game engines 823, each of which may connect over network bus 825 to gaming machines 803. CMS 807 may include location tracking server 831, WRG RTCEM server 833, data warehouse server 835, player tracking server 837, biometric server 839, analysis services server 841, third party interface server 843, slot accounting server 845, floor accounting server 847, progressives server 849, promo control server 851, feature game (such as Bally Live Rewards) server 853, download control server 855, player history database 857, configuration management server 859, browser manager 861, tournament engine server 863 connecting through bus 865 to server host 867 and gaming machines 803. The various servers and gaming machines 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming machines 803. SMS 805 may also have additional servers including a control station (not shown) through which authorized personnel may select options, modify programming, and obtain reports of the connected servers and devices, and obtain reports.

A blockchain interface system of a gaming channel may be incorporated into SMS 805, CMS 807, or another suitable network (including networks dedicated to the management computing device and the gaming machines). The blockchain interface system may be incorporated within one of the servers shown in FIGS. 8A and 8B (e.g., configuration management server 859), or the management blockchain interface system may be a separate device communicatively coupled to the corresponding network. The various CMS and SMS servers are descriptively entitled to reflect the functional executable programming stored thereon and the nature of databases maintained and utilized in performing their respective functions.

Gaming machines 803 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 807 and/or SMS 805 servers and devices, firmware, media, operating systems, and configurations may be downloaded to the system components of respective gaming machines for upgrading or managing floor content and offerings in accordance with operator selections or automatically depending upon CMS 807 and SMS 805 master programming. The data and programming updates to gaming machines 803 are authenticated using conventional techniques prior to install on the system components.

In various embodiments, any of the gaming machines 803 may be a mechanical reel spinning slot machine or a video slot machine or a gaming machine offering one or more of the above-described games including a group play game. Alternately, gaming machines 803 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Pat. App. Publication No. 2008/0139305, entitled “Networked System and Method for Group Play Gaming,” filed on Nov. 9, 2007, which is hereby incorporated by reference in its entirety for all purposes.

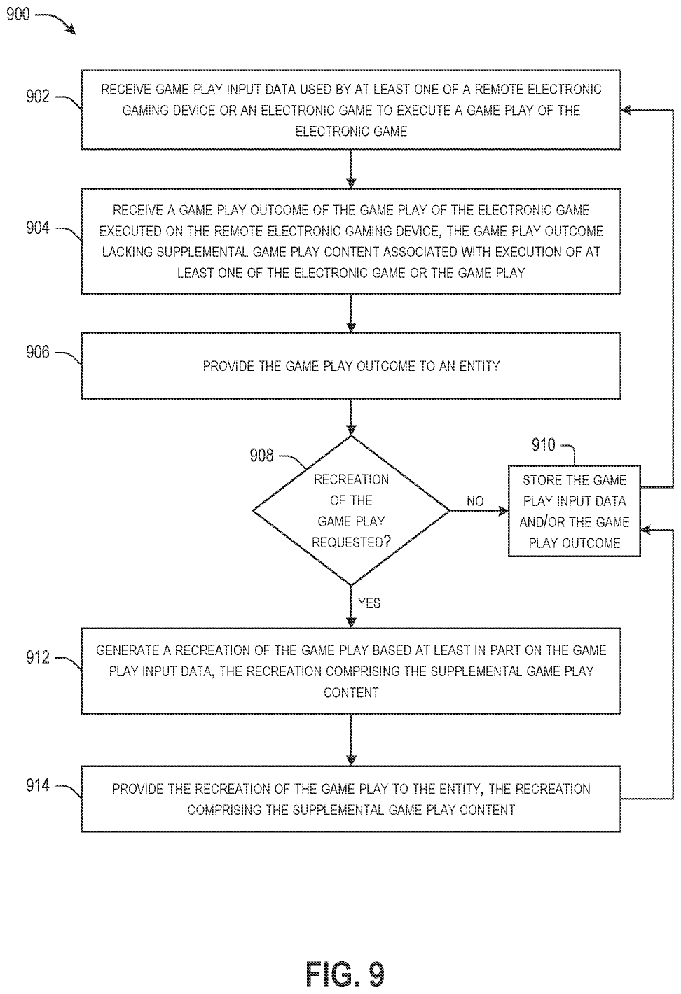

FIG. 9 illustrates a flow diagram of an example, non-limiting computer-implemented method 900 that can facilitate remote execution of a game play according to example embodiments of the present disclosure. In one or more embodiments of the present disclosure, one or more portions of computer-implemented method 900 can be executed and/or implemented by one or more computing systems and/or computing devices including, for example, computing system 110 and/or one or more computing devices 112. Further, in these one or more embodiments, one or more portions of computer-implemented method 900 can be executed and/or implemented as an algorithm and/or as machine-readable instructions (e.g., computer software) using, for instance, one or more hardware components of one or more devices and/or systems disclosed herein.

The example embodiment illustrated in FIG. 9 depicts steps performed in a particular order for purposes of illustration and discussion. However, those of ordinary skill in the art, using the disclosures provided herein, will understand that various steps of computer-implemented method 900 and/or any other methods disclosed herein can be adapted, combined, modified, rearranged, omitted, and/or expanded without deviating from the scope of the present disclosure.

At 902, computer-implemented method 900 can include receiving (e.g., by computing system 110 and/or one or more computing devices 112) game play input data (e.g., a random number) used by at least one of a remote electronic gaming device or an electronic game to execute a game play of the electronic game.

At 904, computer-implemented method 900 can include receiving (e.g., by computing system 110 and/or one or more computing devices 112) a game play outcome of the game play of the electronic game executed on the remote electronic gaming device, the game play outcome lacking supplemental game play content associated with execution of at least one of the electronic game or the game play.

At 906, computer-implemented method 900 can include providing (e.g., by computing system 110 and/or one or more computing devices 112) the game play outcome to an entity.

At 908, computer-implemented method 900 can include determining (e.g., by computing system 110 and/or one or more computing devices 112) whether a recreation of the game play has been requested.

If it is determined at 908 that a recreation of the game play has not been requested, at 910, computer-implemented method 900 can include storing (e.g., by computing system 110 and/or one or more computing devices 112) the game play input data and/or the game play outcome. As illustrated in the example embodiment depicted in FIG. 9, computer-implemented method 900 can further include repeating 902, 904, 906, and/or 908 until it is determined at 908 that a recreation of a game play has been requested, at which time, computer-implemented method 900 can proceed to 912.

If it is determined at 908 that a recreation of the game play has been requested, at 912, computer-implemented method 900 can include generating (e.g., by computing system 110 and/or one or more computing devices 112) a recreation of the game play based at least in part on the game play input data, the recreation comprising the supplemental game play content.

At 914, computer-implemented method 900 can include providing (e.g., by computing system 110 and/or one or more computing devices 112) the recreation of the game play to the entity, the recreation comprising the supplemental game play content. As illustrated in the example embodiment depicted in FIG. 9, computer-implemented method 900 can further include returning to 910 and/or repeating 902, 904, 906, and/or 908 until it is determined at 908 that a recreation of a game play has been requested.

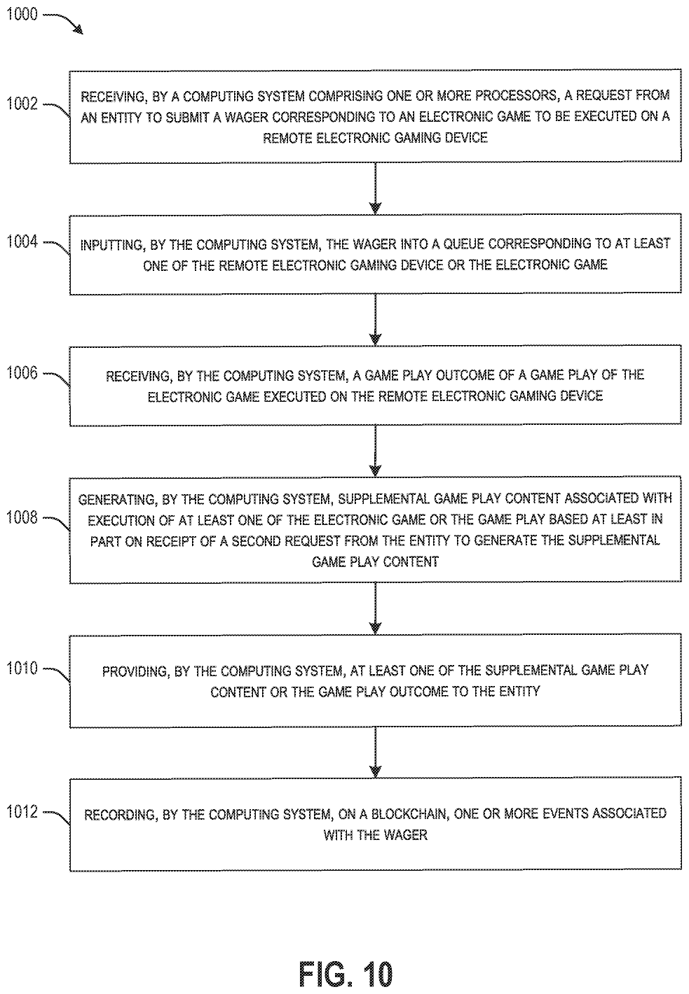

FIG. 10 illustrates a flow diagram of an example, non-limiting computer-implemented method 1000 that can facilitate remote execution of a game play according to example embodiments of the present disclosure. In one or more embodiments of the present disclosure, one or more portions of computer-implemented method 1000 can be executed and/or implemented by one or more computing systems and/or computing devices including, for example, computing system 110 and/or one or more computing devices 112. Further, in these one or more embodiments, one or more portions of computer-implemented method 1000 can be executed and/or implemented as an algorithm and/or as machine-readable instructions (e.g., computer software) using, for instance, one or more hardware components of one or more devices and/or systems disclosed herein.

The example embodiment illustrated in FIG. 10 depicts steps performed in a particular order for purposes of illustration and discussion. However, those of ordinary skill in the art, using the disclosures provided herein, will understand that various steps of computer-implemented method 1000 and/or any other methods disclosed herein can be adapted, combined, modified, rearranged, omitted, and/or expanded without deviating from the scope of the present disclosure.

At 1002, computer-implemented method 1000 can include receiving, by a computing system (e.g., computing system 110 and/or one or more computing devices 112) operatively coupled to one or more processors (e.g., one or more processors 114), a request from an entity to submit a wager corresponding to an electronic game to be executed on a remote electronic gaming device (e.g., one or more remote gaming devices 150A, 150B, 150N, gaming machine 500, electronic gaming machine 601, one or more gaming machines 803, etc.).

At 1004, computer-implemented method 1000 can include inputting, by the computing system (e.g., computing system 110 and/or one or more computing devices 112) the wager into a queue corresponding to at least one of the remote electronic gaming device or the electronic game.

At 1006, computer-implemented method 1000 can include receiving, by the computing system (e.g., computing system 110 and/or one or more computing devices 112) a game play outcome of a game play of the electronic game executed on the remote electronic gaming device (e.g., the output described above with reference to FIGS. 1 and 2).

At 1008, computer-implemented method 1000 can include generating, by the computing system (e.g., computing system 110 and/or one or more computing devices 112) supplemental game play content associated with execution of at least one of the electronic game or the game play (e.g., the supplemental game play content described above with reference to FIGS. 1 and 2) based at least in part on receipt of a second request from the entity to generate the supplemental game play content.

At 1010, computer-implemented method 1000 can include providing, by the computing system (e.g., computing system 110 and/or one or more computing devices 112) at least one of the supplemental game play content or the game play outcome (e.g., data indicative of a win, loss, tie, etc.) to the entity.

At 1012, computer-implemented method 1000 can include recording, by the computing system (e.g., by computing system 110 and/or one or more computing devices 112 using the above-described smart contract) on a blockchain, one or more events associated with the wager.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

Although specific features of various embodiments may be shown in some drawings and not in others, this is for convenience only. In accordance with the principles of the present disclosure, any feature of a drawing may be referenced and/or claimed in combination with any feature of any other drawing.

This written description uses examples to disclose the claimed subject matter, including the best mode, and also to enable any person skilled in the art to practice the claimed subject matter, including making and using any devices or systems and performing any incorporated methods. The patentable scope of the disclosed technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A computing system, comprising:
one or more processors; and
one or more memory devices that store instructions that, when executed by the one or more processors, cause the computing system to perform operations, the operations comprising:
receiving a request from an entity to submit a wager corresponding to an electronic game to be executed on a remote electronic gaming device;
inputting the wager into a queue corresponding to at least one of the remote electronic gaming device or the electronic game;
receiving a game play outcome of a game play of the electronic game executed on the remote electronic gaming device; and
prior to receiving or generating supplemental game play content associated with execution of at least one of the electronic game or the game play, providing the game play outcome to the entity.

2. The computing system of claim 1, wherein the operations further comprise:
receiving a second request from at least one of the entity or a second entity to view a recreation of the game play, the recreation comprising the supplemental game play content.

3. The computing system of claim 1, wherein the game play outcome of the game play lacks supplemental game play content associated with execution of at least one of the electronic game or the game play.

4. The computing system of claim 3, wherein the operations further comprise:
receiving gameplay input data, the game play input data comprising a random number generated by a random number generator.

5. The computing system of claim 1, wherein the operations further comprise:
generating a recreation of the game play based at least in part on game play input data used by at least one of the remote electronic gaming device or the electronic game to execute the game play, the recreation comprising the supplemental game play content.

6. The computing system of claim 1, wherein the operations further comprise:
providing a recreation of the game play to at least one of the entity or a second entity, the recreation comprising the supplemental game play content.

7. The computing system of claim 6, wherein providing the recreation of the game play to at least one of the entity or the second entity comprises:
providing data associated with the recreation of the game play to one or more computing devices associated with at least one of the entity or the second entity, the data associated with the recreation comprising the supplemental game play content.

8. The computing system of claim 7, wherein the one or more computing devices comprise at least one of a local electronic gaming device, a client computing device, a second remote electronic gaming device, or a remote computing device, and wherein the supplemental game play content comprises at least one of graphical content, video content, media content, image content, audio content, or textual content.

9. The computing system of claim 1, wherein inputting the wager into the queue comprises:
inputting the wager into the queue using a smart contract that performs at least one of execution, control, or documentation of one or more events associated with the wager based at least in part on one or more predefined rules.

10. The computing system of claim 1, wherein the operations further comprise:
recording, on a blockchain, one or more events associated with the wager.

11. The computing system of claim 10, wherein the recording, on the blockchain, the one or more events associated with the wager comprises:
recording, on the blockchain, the one or more events associated with the wager using a smart contract that performs at least one of execution, control, or documentation of the one or more events associated with the wager based at least in part on one or more predefined rules, and wherein the one or more events comprise at least one of one or more life cycle events associated with the wager, one or more transactions associated with the wager, or one or more monetary transactions associated with application of the wager.

12. A computer-implemented method, comprising:
receiving, by a computing system comprising one or more processors, a request from an entity to submit a wager corresponding to an electronic game to be executed on a remote electronic gaming device;
inputting, by the computing system, the wager into a queue corresponding to at least one of the remote electronic gaming device or the electronic game;
receiving, by the computing system, a game play outcome of a game play of the electronic game executed on the remote electronic gaming device;
generating, by the computing system, supplemental game play content associated with execution of at least one of the electronic game or the game play based at least in part on receipt of a second request from the entity;
providing, by the computing system, at least one of the supplemental game play content or the game play outcome to the entity; and
recording, by the computing system, on a blockchain, one or more events associated with the wager.

13. The computer-implemented method of claim 12, further comprising:
receiving, by the computing system, a third request from at least one of the entity or a second entity to view a recreation of the game play, the recreation comprising the supplemental game play content.

14. The computer-implemented method of claim 12, further comprising:
generating, by the computing system, a recreation of the game play based at least in part on game play input data used by at least one of the remote electronic gaming device or the electronic game to execute the game play,
wherein the recreation comprises the supplemental game play content,
wherein the supplemental game play content comprises at least one of graphical content, video content, media content, image content, audio content, or textual content, and
wherein the game play input data comprises a random number generated by a random number generator.

15. The computer-implemented method of claim 12, further comprising:
providing, by the computing system, data associated with a recreation of the game play to one or more computing devices associated with at least one of the entity or the second entity,
wherein the data associated with the recreation comprises the supplemental game play content, and
wherein the one or more computing devices comprise at least one of a local electronic gaming device, a client computing device, a second remote electronic gaming device, or a remote computing device.

16. The computer-implemented method of claim 12, wherein inputting, by the computing system, the wager into the queue comprises:
inputting, by the computing system, the wager into the queue using a smart contract that performs at least one of execution, control, or documentation of one or more events associated with the wager based at least in part on one or more predefined rules.

17. The computer-implemented method of claim 12, wherein recording, by the computing system, on the blockchain, the one or more events associated with the wager comprises:
recording, by the computing system, on the blockchain, the one or more events associated with the wager using a smart contract that performs at least one of execution, control, or documentation of the one or more events associated with the wager based at least in part on one or more predefined rules, wherein the one or more events comprise at least one of one or more life cycle events associated with the wager, one or more transactions associated with the wager, or one or more monetary transactions associated with application of the wager.

18. An electronic gaming device comprising:
one or more processors; and
one or more memory devices that store instructions that, when executed by the one or more processors, cause the electronic gaming device to perform operations, the operations comprising:
obtaining game play input data to be used to execute a game play of an electronic game associated with the electronic gaming device;
executing the game play based at least in part on the game play input data;
generating a game play outcome of the game play based at least in part on execution of the game play, the game play outcome lacking supplemental game play content associated with execution of at least one of the electronic game or the game play; and
providing the game play input data and the game play outcome lacking supplemental game play content to one or more remote computing devices to generate a recreation of the game play via the one or more remote computing devices based at least in part on the game play input data and the game play outcome lacking supplemental game play content, the recreation comprising the supplemental game play content.

19. The electronic gaming device of claim 18, wherein the operations further comprise:
receiving a request from an entity via the one or more remote computing devices to provide the game play input data, and wherein the game play input data comprises a random number generated by a random number generator associated with the electronic gaming device.

20. The electronic gaming device of claim 18, wherein the supplemental game play content comprises at least one of graphical content, video content, media content, image content, audio content, or textual content, and wherein the one or more remote computing devices comprise at least one of a server computing device, a second electronic gaming device, a client computing device, or a remote computing device.
